(19) United States
(12) Patent Application Publication
(10) Pub. No.: US 2025/0339771 A1
(43) Pub. Date: Nov. 6, 2025

(54) MIXED-REALITY GAMING SYSTEM AND METHODS FOR USE THEREWITH

(71) Applicant: Copenhagen Game Productions ApS, Copenhagen (DK)

(72) Inventors: Tim May, Copenhagen (DK); George Batog, Plymouth, MN (US)

(73) Assignee: Copenhagen Game Productions ApS, Copenhagen (DK)

(21) Appl. No.: 19/181,574

(22) Filed: Apr. 17, 2025

Related U.S. Application Data
(60) Provisional application No. 63/640,612, filed on Apr. 30, 2024.
(60) Provisional application No. 63/640,620, filed on Apr. 30, 2024.
(60) Provisional application No. 63/640,627, filed on Apr. 30, 2024.
(60) Provisional application No. 63/640,647, filed on Apr. 30, 2024.
(60) Provisional application No. 63/640,654, filed on Apr. 30, 2024.

(51) Int. Cl. A63F 13/52; A63F 13/35

(52) U.S. Cl. CPC A63F 13/52; A63F 13/35; A63F 2300/8082

(57) ABSTRACT

A mixed-reality gaming system operates by: receiving first telemetry data corresponding to a first gaming object in a first game space, wherein the first gaming object is a first physical object that operates in the first game space under control of a first client device of a first player and wherein the first game space is a physical space in proximity to the first client device; generating first gaming data corresponding to a mixed-reality game, the first gaming data based on a positioning of the first gaming object in the mixed-reality game; and sending the first gaming data to a second client device of a second player controlling a second gaming object in the mixed-reality game to facilitate real-time remote game play of the mixed-reality game between the first gaming object and the second gaming object.

### CROSS-REFERENCE TO RELATED APPLICATIONS

The present U.S. Utility Patent Application claims priority pursuant to 35 U.S.C. § 119(e) to U.S. Provisional Application No. 63/640,612, entitled “AUGMENTED REALITY GAMING SYSTEM AND METHODS FOR USE THEREWITH”, filed Apr. 30, 2024; U.S. Provisional Application No. 63/640,620, entitled “POSITIONING AND COMMUNICATION UNIT FOR USE WITH A GAMING SYSTEM AND METHODS FOR USE THEREWITH”, filed Apr. 30, 2024; U.S. Provisional Application No. 63/640,627, entitled “MODULAR GAME PIECES WITH ARTICULATED CONTROL FOR USE WITH A GAMING SYSTEM AND METHODS FOR USE THEREWITH”, filed Apr. 30, 2024; U.S. Provisional Application No. 63/640,647, entitled “MULTIMODAL GAMING SYSTEM AND METHODS FOR USE THEREWITH”, filed Apr. 30, 2024; and U.S. Provisional Application No. 63/640,654, entitled “GAMING SYSTEM WITH SELECTIVE ARTIFICIAL INTELLIGENCE CONTROL AND METHODS FOR USE THEREWITH”, filed Apr. 30, 2024, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates to computer systems and gaming devices for facilitating virtual and augmented reality games.

### BRIEF DESCRIPTION OF THE SEVERAL VIEWS OF THE DRAWING(S)

FIG. 1A is a schematic block diagram of an example mixed-reality gaming system;

FIG. 1B is a pictorial block diagram of an example mixed-reality gaming system;

FIG. 1C is a schematic block diagram of an example gaming object in a mixed-reality gaming system;

FIG. 1D is a schematic block diagram of an example ejection process of a gaming object in mixed-reality gaming system;

FIG. 1E is a schematic block diagram of an example mixed-reality gaming system;

FIG. 1F is a pictorial diagram of example components of a mixed-reality gaming system;

FIGS. 1G-FIG. 1I are a pictorial diagrams of example gaming objects of a mixed-reality gaming system;

FIGS. 1J-FIG. 1O are pictorial diagrams of example screen displays of a mixed-reality gaming system;

FIG. 1P is a pictorial diagram of an example game space;

FIG. 1Q is a flow diagram of an example method for use with a mixed-reality gaming system;

FIG. 1R is a flow diagram of an example method for use with a mixed-reality gaming system;

FIG. 1S is a flow diagram of an example method for use with a mixed-reality gaming system;

FIGS. 2A through 2E are schematic block diagrams of embodiments of computing entities that are part of an improved computer technology;

FIGS. 2F through 2L are schematic block diagrams of embodiments of computing devices that form at least a portion of a computing entity; and

FIG. 2M is a schematic block diagram of an embodiment of a database.

### DETAILED DESCRIPTION OF THE INVENTION

The present disclosure relates to mixed-media gaming systems that produce multicolor displays. These systems and the techniques described herein rely on color and therefore can be best understood in light of the many color drawings that are presented herein.

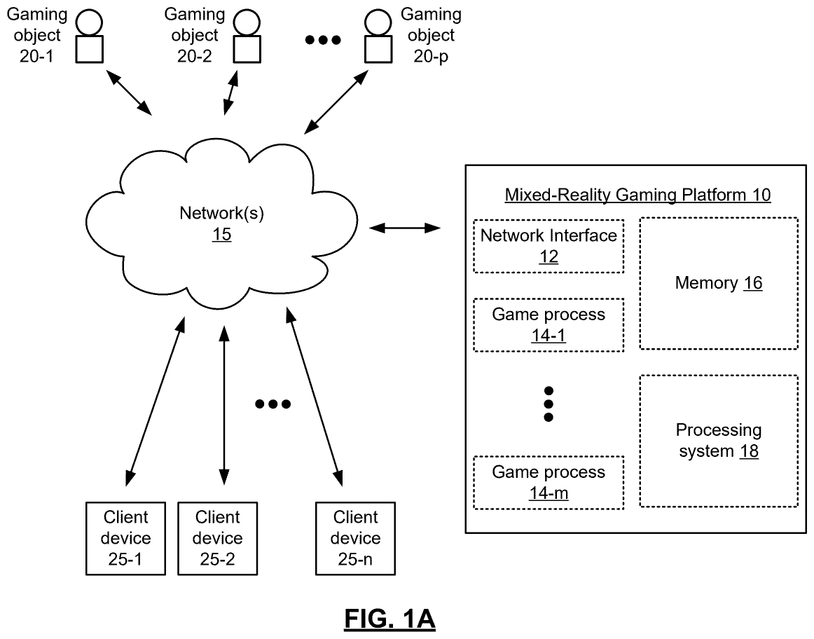

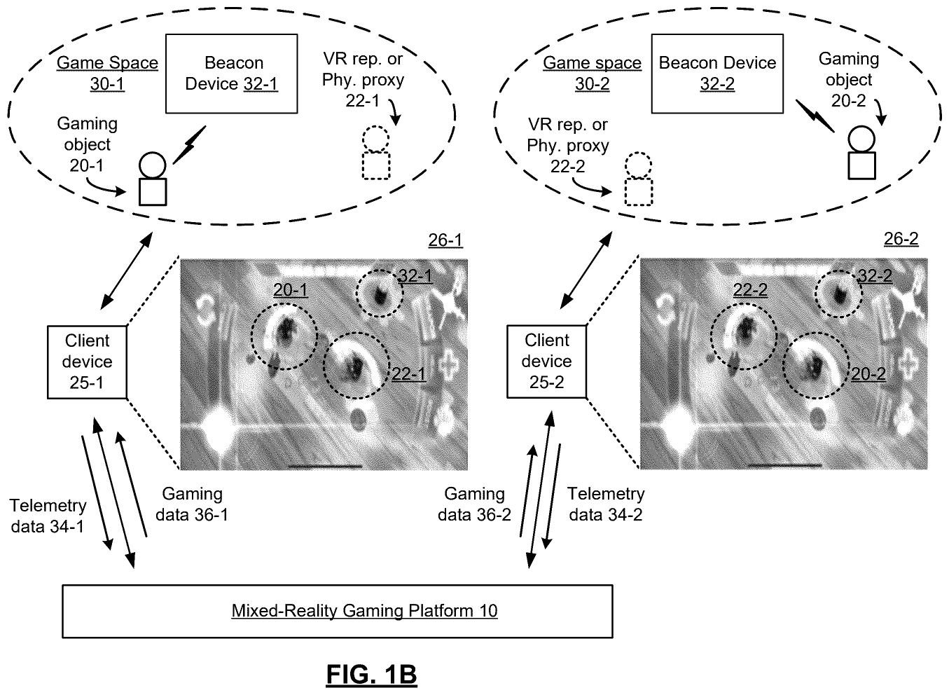

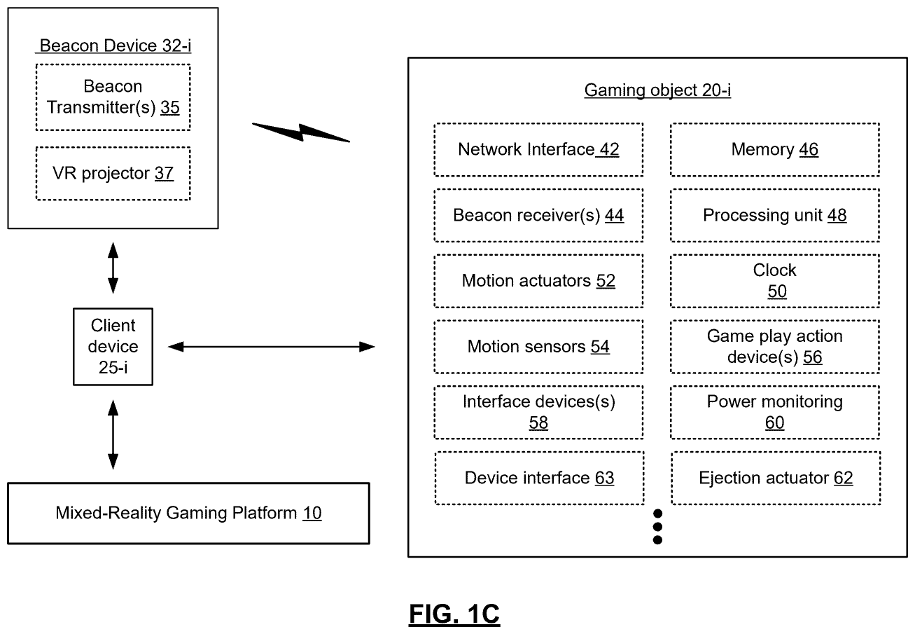

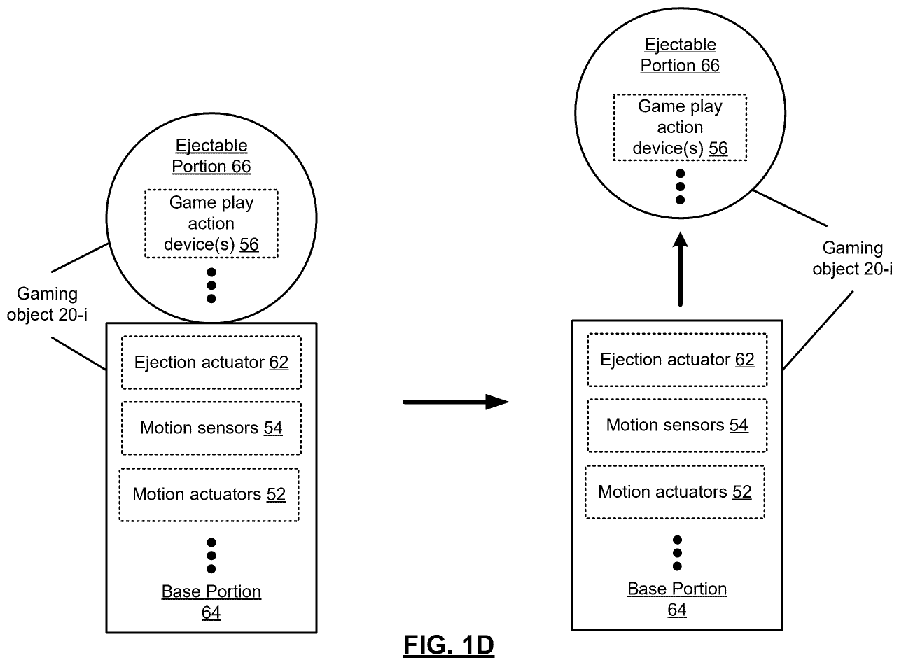

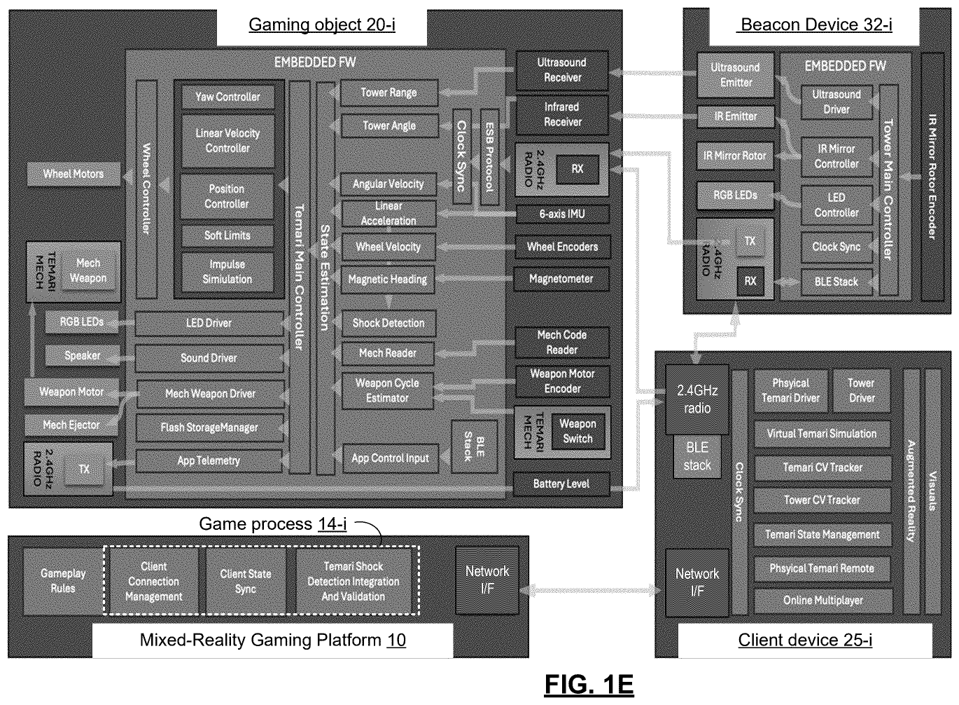

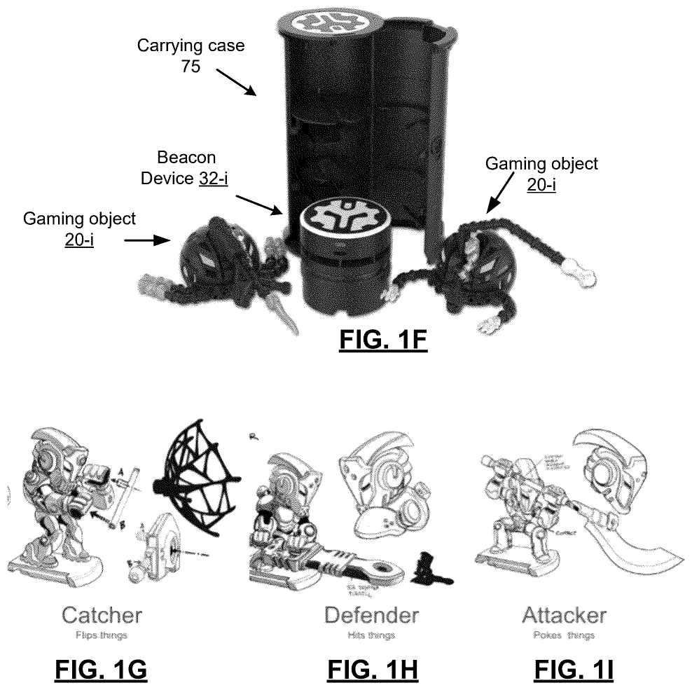

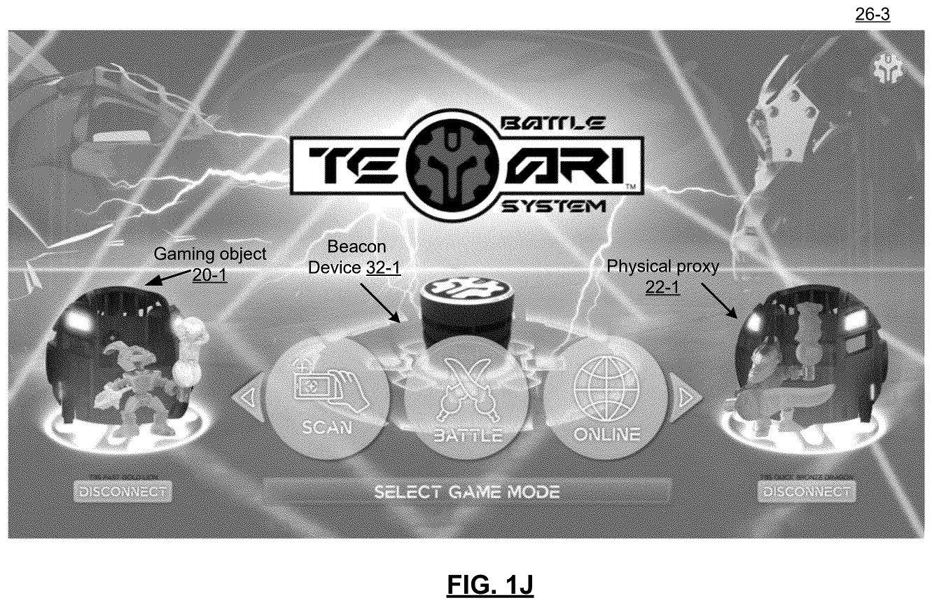

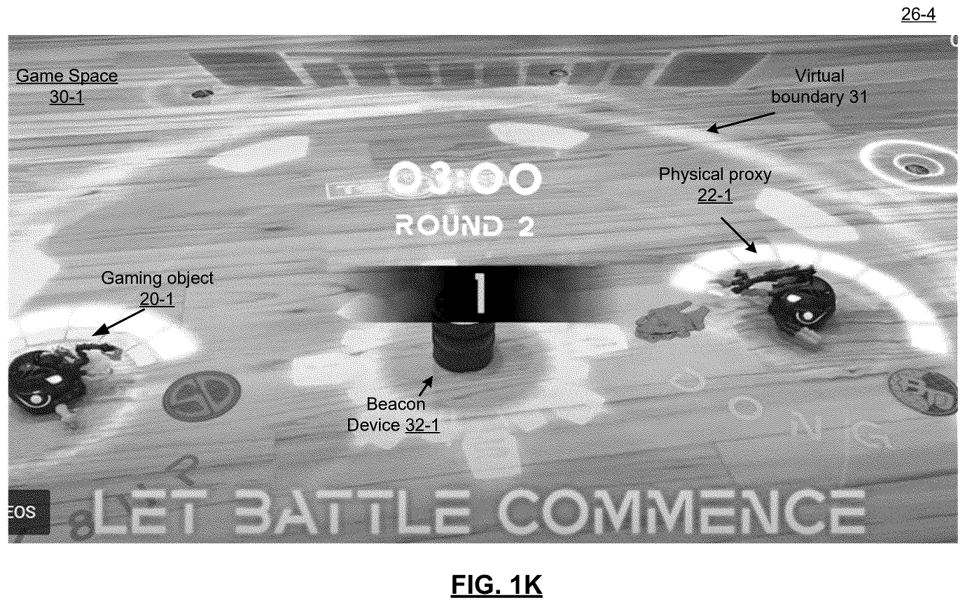

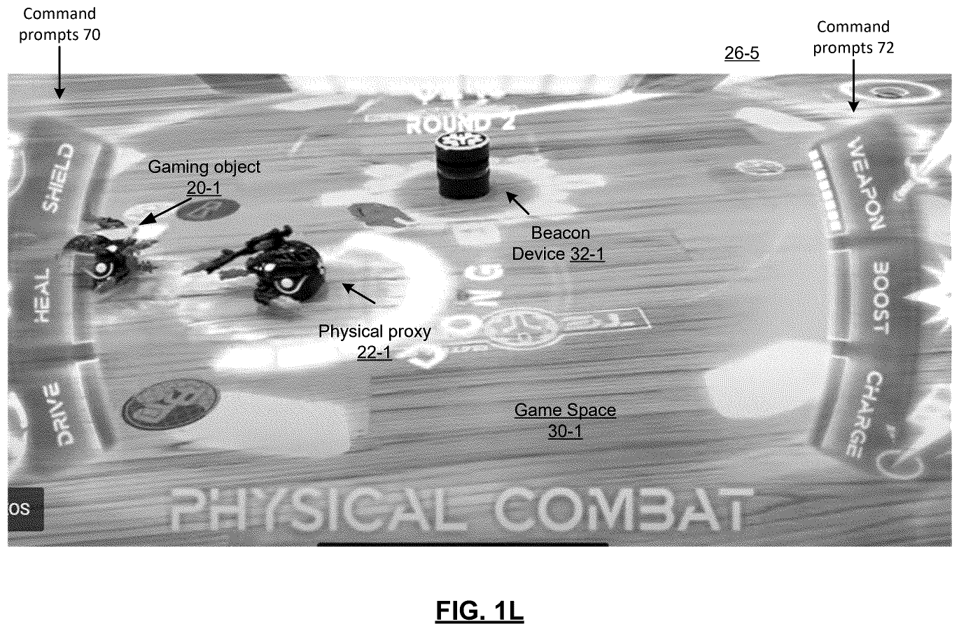

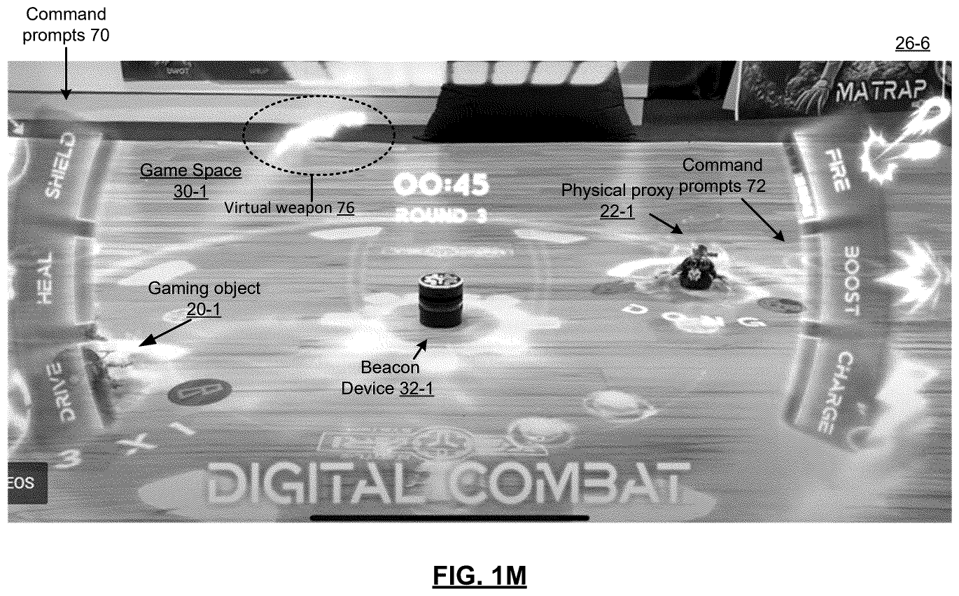

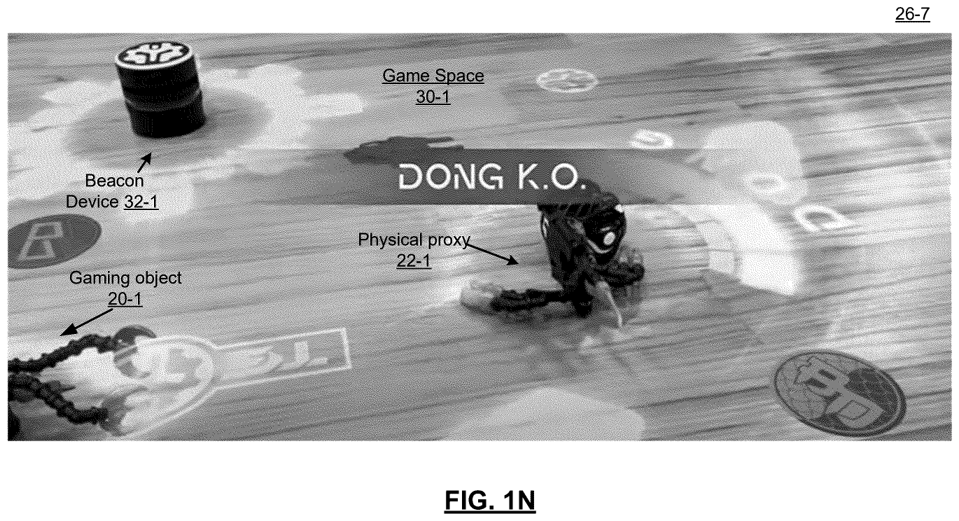

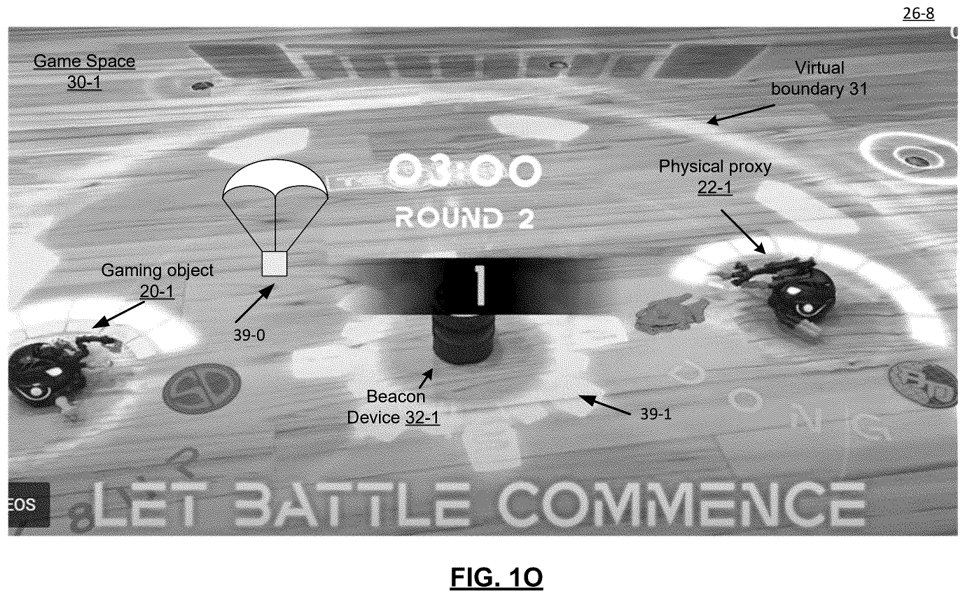

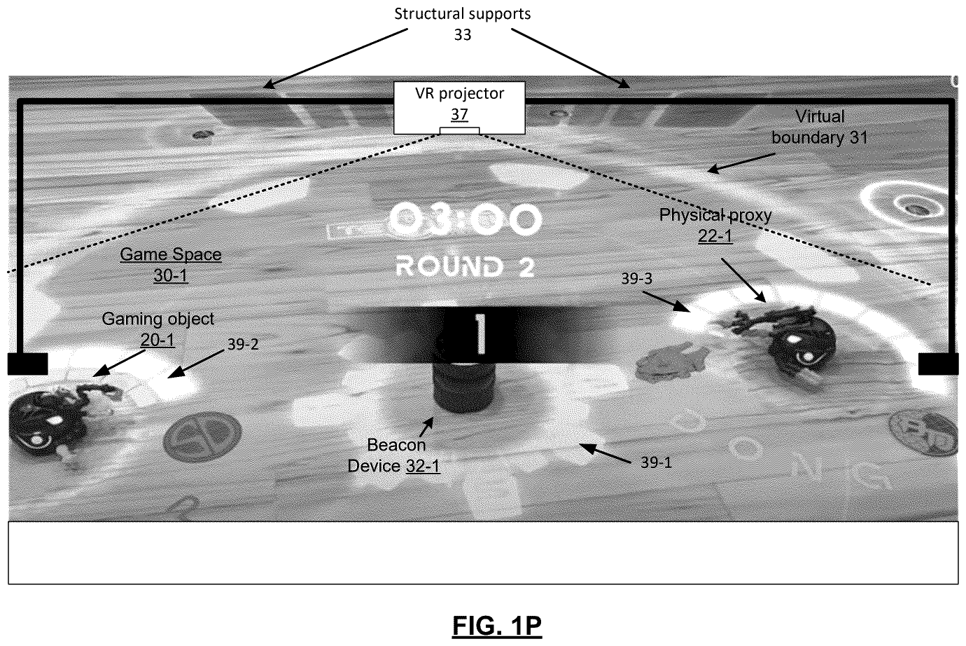

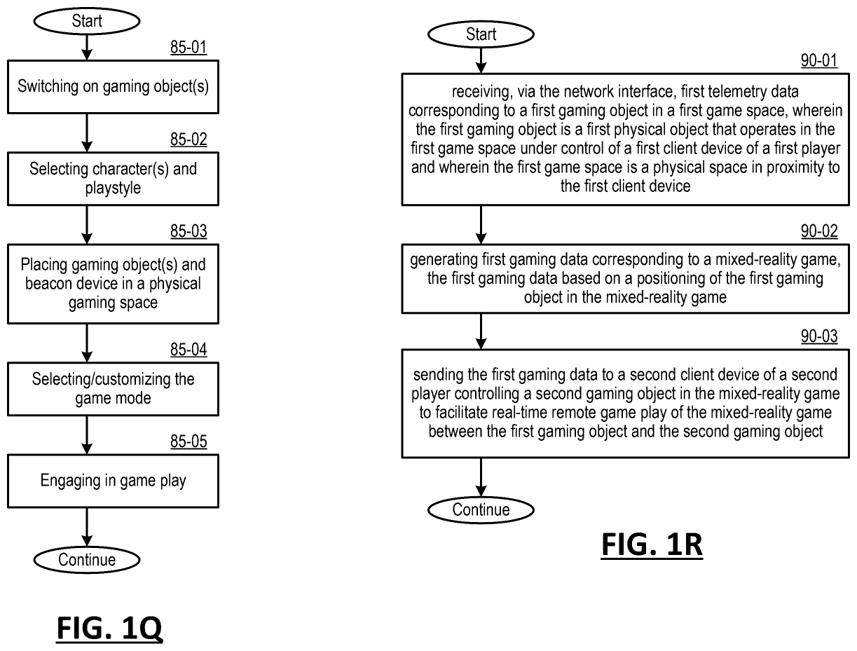

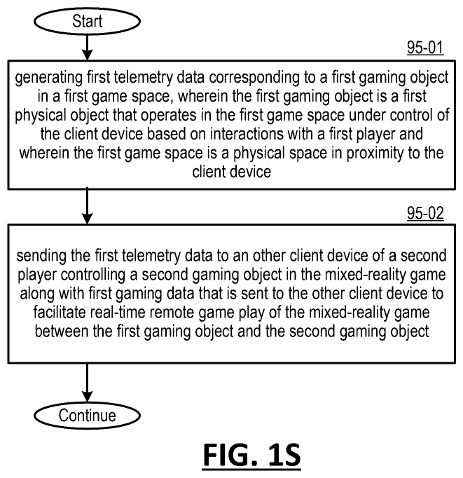

FIG. 1A is a schematic block diagram of a mixed-reality gaming system that includes a mixed-reality gaming platform 10 a plurality of gaming objects 20-1, 20-2 . . . 20-p and a plurality of client devices 25-1, 25-2 . . . 25-n that communicate via one or more networks 15 including personal or local area networks that operate via protocols such as Bluetooth, Bluetooth low energy (BLE), ultrawideband (UWB), Wi-Fi, etc., a wide area network such as an LTE or 5G wireless network, the Internet and/or other personal area, wide area or local area network, wired or wireless, and either public or private.

In the example shown, the gaming objects 20-1, 20-2 . . . 20-p are physical objects (that can also be referred to as robots, bots, Temari, Temari robots, battle robots, etc.) that can be modular in their design and can each operate under control of a corresponding one of the client devices 25-1, 25-2 . . . 25-n in order to facilitate game play of a mixed-reality game such as a robot battle or other interaction between two or more such gaming objects, and/or between one or more single gaming object and one or more virtual gaming objects or other game characters. Further examples regarding the implementation of such gaming objects along with various example functions and features are described in greater detail in conjunction with the descriptions that follow.

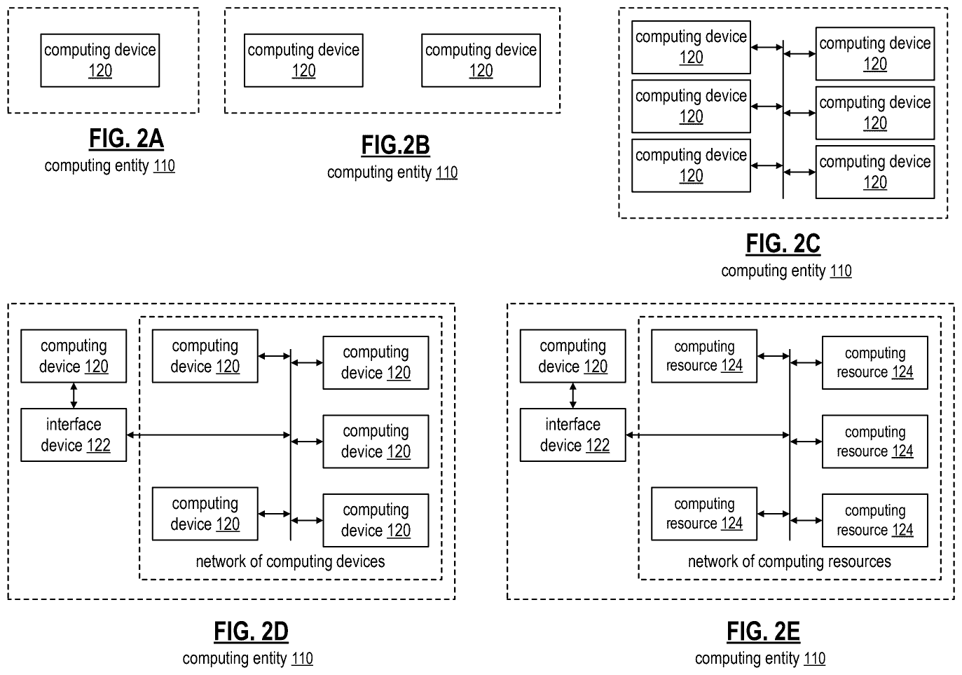

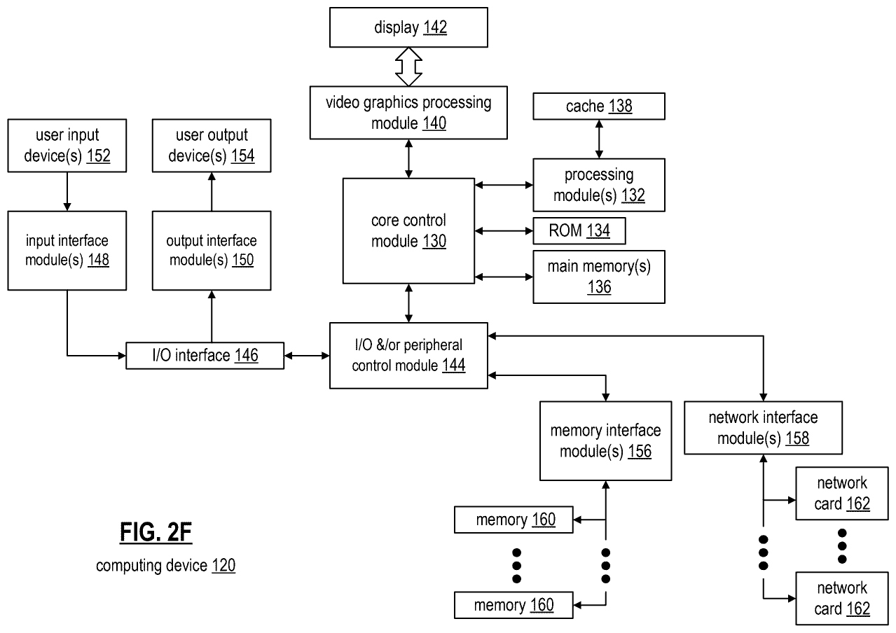

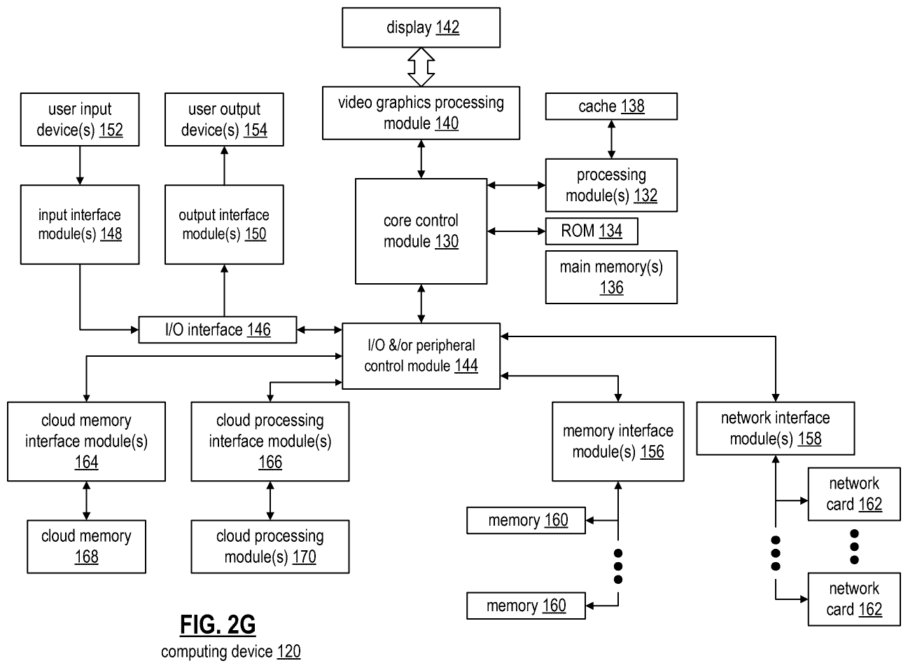

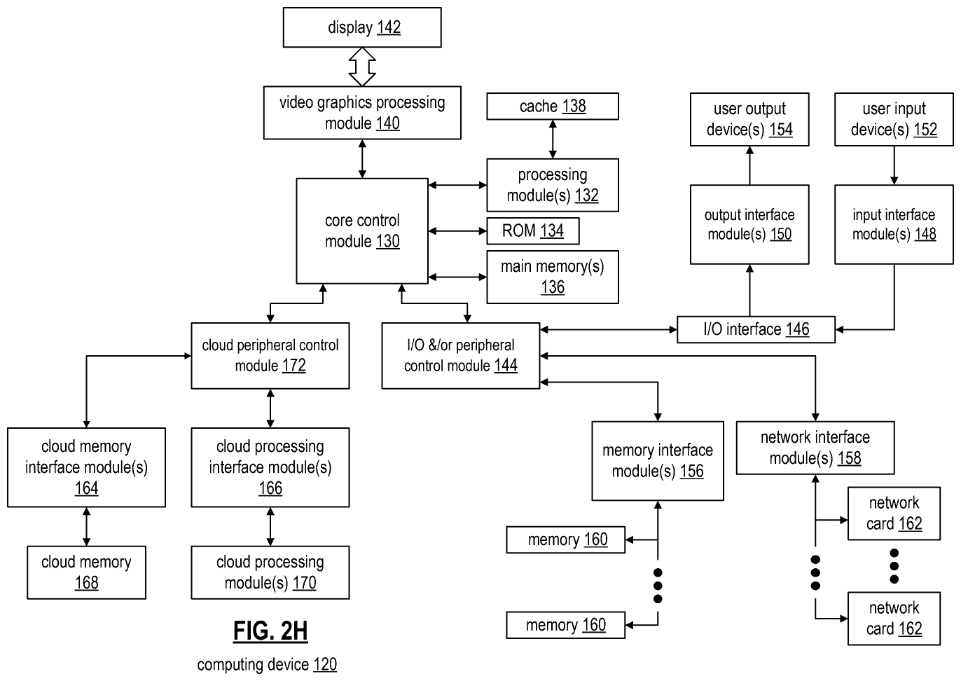

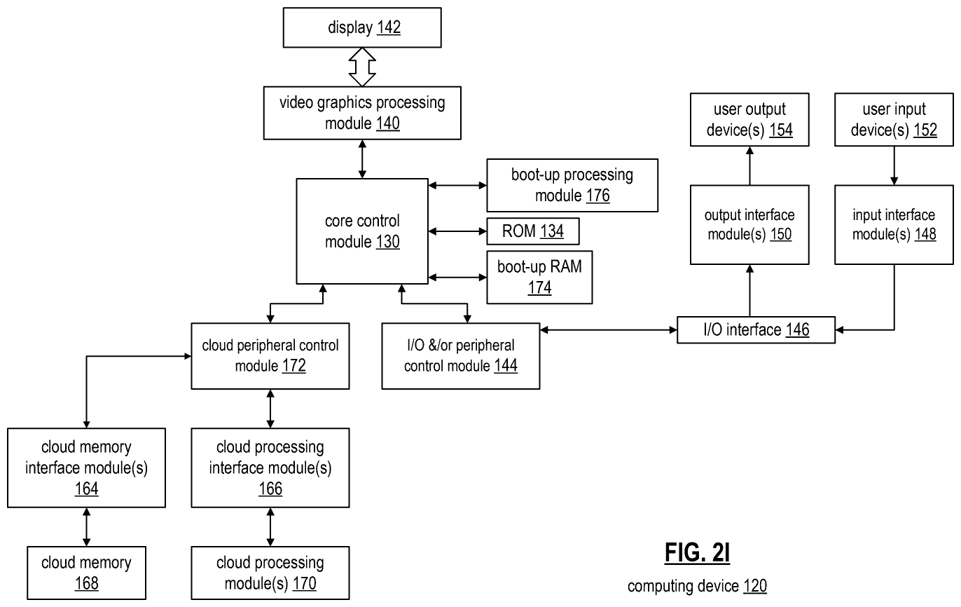

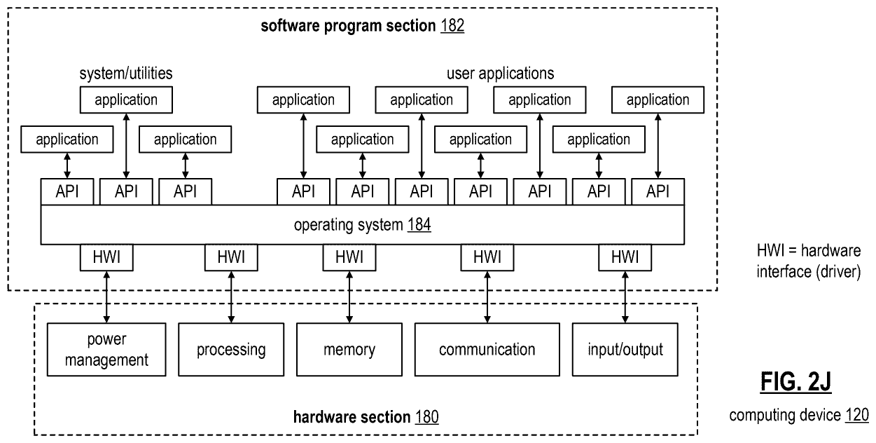

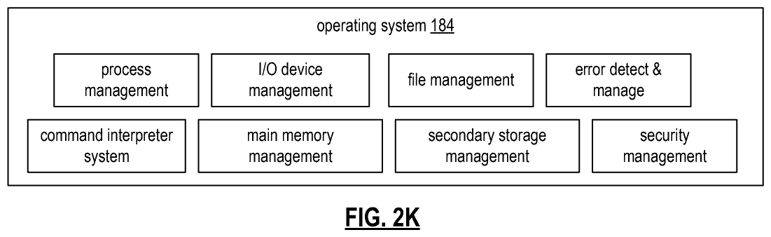

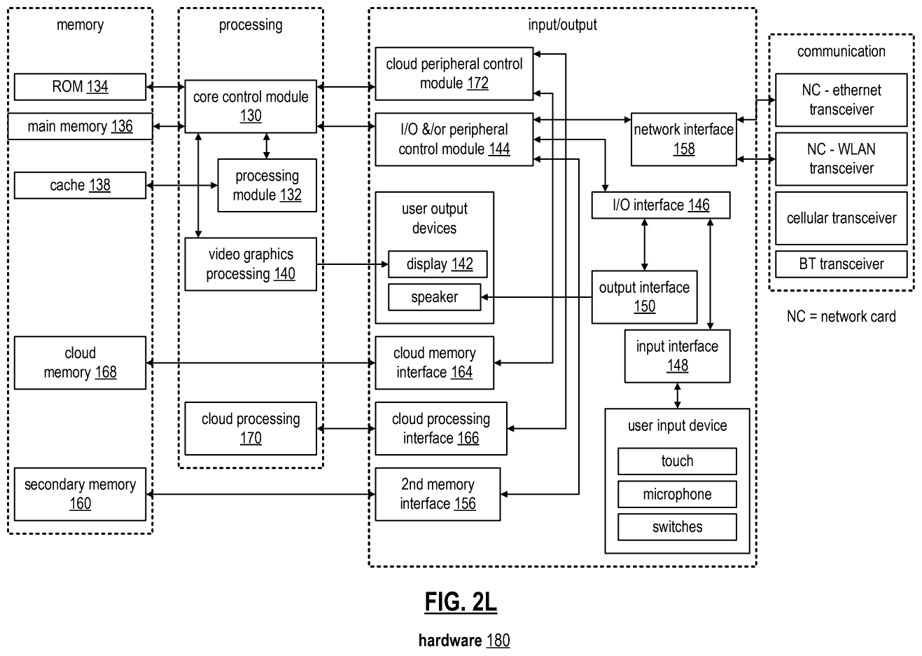

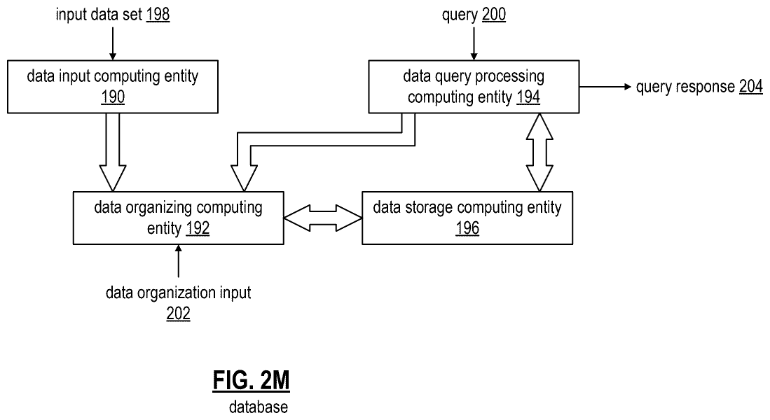

The client devices 25-1, 25-2 . . . 25-n (which can each be referred to as a host device, local host, local host device, host simulation device, local Temari game host and further variations of any of the foregoing) can each be implemented via a gaming controller or other personal gaming device, smartphone, tablet, laptop or notebook computer, by VR/AR goggles or glasses, and or by other handheld, mobile or personal computing or gaming systems and/or other devices having a screen display, camera and/or is otherwise capable of communicating corresponding ones of the gaming objects 20-1, 20-2 . . . 20-p via one or more networks 15, running software and/or firmware to support a mixed-reality one or more gaming applications, to present mixed-reality displays (e.g., screen displays) to a user (e.g., a player) of the client device and further to receive and forward commands, input, other instructions and/or data. Furthermore, in various examples, the client devices 25-1, 25-2 . . . 25-n can each be implemented via a computing entity 110 that will be described in greater detail in conjunction with FIGS. 2A-2M that follow.

The mixed-reality gaming platform 10 includes a network interface 12 including one or more individual interface devices for communicating with the client devices 25-1, 25-2 . . . 25-n via one or more networks 15, a memory that stores operational instructions in software and/or firmware and a processing system that executes the operational instructions in order to support the contemporaneous operation of game processes 14-1 . . . 14-m corresponding to the facilitation of m separate and independent mixed-reality games. Furthermore, the mixed-reality gaming platform 10 can include other components not expressly shown. In various examples, the mixed-reality gaming platform 10 can be implemented via a computing entity 110 that will be described in greater detail in conjunction with FIGS. 2A-2M that follow. Particularly, while shown as a single unit, the mixed-reality gaming platform 10 can be implemented via decentralized or cloud-based computer system or other distributed or network-based computer system. Furthermore, the functionality of the mixed-reality gaming platform 10 can be incorporated into one or more client devices 25-1, 25-2 . . . 25-n that facilitate game play via bidirectional; communication with one another via one or more networks 15—e.g., between one or more client devices—without an intervening game platform or game server.

In various examples, the mixed-reality gaming system disclosed herein enables a physical robot or other game object 20-i to interact with a virtual game world simulation (e.g., a mixed-reality multiplayer gaming environment) hosted on one or more client devices 25-i in order to facilitate game play of a mixed-reality game and via interactions the client devices, facilitate a mixed reality representation of the game world that can be displayed to a player, including virtual augmentations of the physical devices, as well as other similarly capable physical robots or other gaming objects that participate in that same game world—either directly in the same physical space or via remote presence intermediated by a network 15 and manifested though either a local physical robot avatar (e.g., a physical proxy) or a virtual representation corresponding to the remote game object(s).

In other examples, one or more of the client devices 25-i operate as observers of the mixed-reality game, reproducing mixed-reality game displays on the display of their device without direct communication with the gaming object(s) in the game and/or without directly controlling of one or more the gaming objects in the game. In various examples, the observers are merely passive, allowing the users of these client devices 25-i to observe the game play without any further interaction with the game. In various other examples, the observers can be active observers that can interact with the game play via the introduction and/or control of a virtual representation (e.g., an additional virtual player), the introduction and/or control of game play settings, configurations, obstacles or other challenges, components or representations of the gaming space, one or more virtual non-player characters, other virtual representations, virtual elements and/or other virtual object(s) and/or via the creation of other commands and/or other interactions with the game, the game space, the gaming objects, proxies, display and/or other aspects of the game play.

In particular, among other benefits, the mixed-reality gaming system improves the technology of computer systems by enabling multiuser games played by users at remote locations utilizing one or more physical gaming objects and by synchronizing the one or more physical gaming objects into the mixed reality remote game play in real-time.

Consider the following example where a mixed-reality gaming platform 10 includes a network interface 12, a processing system 18 having one or more processors and a memory that stores executable instructions of a game process that, when executed by the processing system, cause the client device to:
receiving, via the network interface, first telemetry data corresponding to a first gaming object in a first game space, wherein the first gaming object is a first physical object that operates in the first game space under control of a first client device of a first player and wherein the first game space is a physical space in proximity to the first client device;
generating first gaming data corresponding to a mixed-reality game, the first gaming data based on a positioning of the first gaming object in the mixed-reality game; and
sending the first gaming data to a second client device of a second player controlling a second gaming object in the mixed-reality game to facilitate real-time remote game play of the mixed-reality game between the first gaming object and the second gaming object.

In addition or in the alternative to any of the foregoing, the second gaming object is a second physical object that operates in a second game space under control of the second client device and wherein the second game space is a physical space in proximity to the second client device and remote from the first game space.

In addition or in the alternative to any of the foregoing, the first telemetry data includes first position and orientation data corresponding to the positioning of the first gaming object relative to a first beacon device in the first game space; the first gaming data facilitates real-time game play of the mixed-reality game between the first gaming object and the second gaming object based on a first mixed-reality display that includes a first virtual reality representation as a proxy for the first gaming object and is presented to the second player via the second client device; and the first mixed reality display positions and orients the first virtual reality representation in the second game space based on the first position and orientation data.

In addition or in the alternative to any of the foregoing, the operations of the at least one game process further include:
receiving, via the network interface, second telemetry data corresponding to the second gaming object in the second game space;
generating second gaming data corresponding to the mixed-reality game, the second gaming data representing the second gaming object as a second virtual reality representation as a proxy for the second gaming object; and
sending the second gaming data to the first client device to facilitate the real-time remote game play of the mixed-reality game between the first gaming object and the second gaming object;
wherein the second telemetry data includes second position and orientation data corresponding to the second gaming object relative to a second beacon device in the second game space;
wherein the second gaming data facilitates the real-time game play of the mixed-reality game between the first gaming object and the second gaming object based on a second mixed-reality display that includes a second virtual reality representation as a proxy for the second gaming object and is presented to the first player via the first client device; and
wherein the second mixed reality display positions and orients the second virtual reality representation in the first game space based on the second position and orientation data.

In addition or in the alternative to any of the foregoing, the operations of the at least one game process further include:
receiving, via the network interface, first action data corresponding to other game play actions of the first gaming object, wherein the first gaming data and the first mixed-reality display are further generated to reflect the other game play actions of the first gaming object; and
receiving, via the network interface, second action data corresponding to other game play actions of the second gaming object, wherein the second gaming data and the second mixed-reality display are further generated to reflect the other game play actions of the first gaming object.

In addition or in the alternative to any of the foregoing, the second mixed-reality display includes a visual enhancement of the first gaming object that is based on augmented reality.

In addition or in the alternative to any of the foregoing, the first mixed-reality display includes a visual enhancement of the second gaming object that is based on augmented reality.

In addition or in the alternative to any of the foregoing, the first telemetry data includes position and orientation data corresponding to the positioning of the first gaming object relative to a first beacon device in the first game space; wherein the first gaming data facilitates real-time game play of the mixed-reality game between the first gaming object and the second gaming object based a first physical proxy for the first gaming object in the second game space and based on a first mixed-reality display that is presented to the second player via the second client device; and wherein the second gaming data facilitates orientation of the first physical proxy in the second game space based on the position and orientation data.

In addition or in the alternative to any of the foregoing, the first beacon device includes at least one beacon transmitter configured to transmit at least one wireless beacon and the first gaming object includes at least one beacon receiver and wherein the first position and orientation data is generated based on reception of the at least one beacon via the at least one beacon receiver.

In addition or in the alternative to any of the foregoing, the at least one wireless beacon includes one or more of: an ultrasonic beacon or an infrared beacon.

In addition or in the alternative to any of the foregoing, the infrared beacon is emitted vertically and reflected by a spinning mirror that redirects the infrared beacon across a 360 sweep in a horizontal plane.

In addition or in the alternative to any of the foregoing, the first gaming device determines a distance to the first beacon device based on a one-way time of travel of an ultrasonic beacon from the first beacon device to the first gaming device.

In addition or in the alternative to any of the foregoing, the ultrasonic beacon is reflected by a conic reflector that directs the ultrasonic beacon omnidirectionally across a horizontal plane.

In addition or in the alternative to any of the foregoing, the at least one wireless beacon transmits a clock synchronization signal that facilitates determination of a distance from the first gaming object to the first beacon device and an orientation from the first gaming object to the first beacon device.

In addition or in the alternative to any of the foregoing, a projector emits an optical projection of one or more virtual elements associated with the first mixed-reality display upon the second gaming space.

In addition or in the alternative to any of the foregoing, an additional client device operates as an observer of the mixed-reality game, reproducing mixed-reality game displays on the display of the additional client device.

In addition or in the alternative to any of the foregoing, the additional client device operates as a passive observer allowing users of the additional client device to observe the game play without any interaction.

In addition or in the alternative to any of the foregoing, the additional client device operates as an active observer allowing users of the additional client device to control one or more virtual elements of the game play without any interaction.

In addition or in the alternative to any of the foregoing, the first gaming device includes a plurality of motion sensors that generate motion data, wherein the first position and orientation data is generated further based on the motion data and wherein the motion sensors include at least one: accelerometer, gyrometer, magnetometer and wheel encoder corresponding to at least one wheel of the first gaming device.

In addition or in the alternative to any of the foregoing, the first client device includes a camera configured to capture image data of the first game space, wherein the first client device utilizes computer vision to generate tracking data associated with the first gaming device and the first beacon device and wherein the first position and orientation data is generated further based on the tracking data.

In addition or in the alternative to any of the foregoing, the first gaming data includes impact data generated based on the motion data and responsive to one or more physical impacts to the first gaming object by the second gaming object during the real-time remote game play of the mixed-reality game between the first gaming object and the second gaming object and wherein the hits data is further based on detection of virtual impacts to the first gaming object responsive to the real-time remote game play of the mixed-reality game.

In addition or in the alternative to any of the foregoing, the first gaming device includes a base portion, an ejectable portion that is mechanically coupleable to the base portion and an ejection actuator, and wherein the ejection actuator operates to eject the ejectable portion from the base portion based on the impact data.

In addition or in the alternative to any of the foregoing, the first client device includes a camera configured to capture image data of the first game space, wherein the first client device generates the first mixed-reality display based on the captured image data.

In addition or in the alternative to any of the foregoing, the first gaming device includes a plurality of motion actuators for controlling motion of the first gaming device and at least one game play action device that produces other game play actions of the first gaming device that operate under control of commands generated by the first client device.

In addition or in the alternative to any of the foregoing, the first gaming object operates in the first game space under control of the first client device in one of a plurality of modes selected by the first player, wherein the plurality of modes include two or more of: player controlled game play, artificial intelligence (AI) assisted game play or AI controlled game play.

In addition or in the alternative to any of the foregoing, consider the following example where a client device 25 includes a network interface, a processing system having one or more processors and a memory that stores executable instructions of a gaming application that, when executed by the processing system, cause the client device to perform operations that include:
generating first telemetry data corresponding to a first gaming object in a first game space, wherein the first gaming object is a first physical object that operates in the first game space under control of the client device based on interactions with a first player and wherein the first game space is a physical space in proximity to the client device; and
sending the first telemetry data to an other client device of a second player controlling a second gaming object in the mixed-reality game along with first gaming data that is sent to the other client device to facilitate real-time remote game play of the mixed-reality game between the first gaming object and the second gaming object.

In addition or in the alternative to any of the foregoing, the second gaming object is a second physical object that operates in a second game space under control of the other client device and wherein the second game space is a physical space in proximity to the other client device and remote from the first game space.

In addition or in the alternative to any of the foregoing, the first telemetry data includes first position and orientation data corresponding to the positioning of the first gaming object relative to a first beacon device in the first game space; wherein the first gaming data facilitates real-time game play of the mixed-reality game between the first gaming object and the second gaming object based on a first mixed-reality display that includes a first virtual reality representation as a proxy for the first gaming object and is presented to the second player via the other client device; and wherein the first mixed reality display positions and orients the first virtual reality representation in the second game space based on the first position and orientation data.

In addition or in the alternative to any of the foregoing, the operations of the at least one game application further include:
receiving second gaming data corresponding to the mixed-reality game that is generated based on second telemetry data corresponding to the second gaming object in the second game space, the second gaming data representing the second gaming object as a second virtual reality representation as a proxy for the second gaming object, wherein the second telemetry data includes second position and orientation data corresponding to the second gaming object relative to a second beacon device in the second game space; and
generating a second mixed-reality display presented to the first player that includes a second virtual reality representation as a proxy for the second gaming object and is via the client device, wherein the second mixed reality display positions and orients the second virtual reality representation in the first game space based on the second position and orientation data.

In addition or in the alternative to any of the foregoing, the first telemetry data includes first action data corresponding to other game play actions of the first gaming object, wherein the first telemetry data and the first mixed-reality display are further generated to reflect the other game play and the second gaming data includes second action data corresponding to other game play actions of the second gaming object, and wherein the second gaming data and the second mixed-reality display are further generated to reflect the other game play actions of the first gaming object.

In addition or in the alternative to any of the foregoing, the second mixed-reality display includes a visual enhancement of the first gaming object that is based on augmented reality.

In addition or in the alternative to any of the foregoing, the first mixed-reality display includes a visual enhancement of the second gaming object that is based on augmented reality.

In addition or in the alternative to any of the foregoing, the first telemetry data includes position and orientation data corresponding to the positioning of the first gaming object relative to a first beacon device in the first game space; wherein the first gaming data facilitates real-time game play of the mixed-reality game between the first gaming object and the second gaming object based a first physical proxy for the first gaming object in the second game space and based on a first mixed-reality display that is presented to the second player via the other client device; and wherein the second gaming data facilitates orientation of the first physical proxy in the second game space based on the position and orientation data.

In addition or in the alternative to any of the foregoing, the first beacon device includes at least one beacon transmitter configured to transmit at least one wireless beacon and the first gaming object includes at least one beacon receiver and wherein the first position and orientation data is generated based on reception of the at least one beacon via the at least one beacon receiver.

In addition or in the alternative to any of the foregoing, a projector emits an optical projection of one or more virtual elements associated with the first mixed-reality display upon the second gaming space.

In addition or in the alternative to any of the foregoing, an additional client device operates as an observer of the mixed-reality game, reproducing mixed-reality game displays on the display of the additional client device.

In addition or in the alternative to any of the foregoing, the additional client device operates as a passive observer allowing users of the additional client device to observe the game play without any interaction.

In addition or in the alternative to any of the foregoing, the additional client device operates as an active observer allowing users of the additional client device to control one or more virtual elements of the game play without any interaction.

In addition or in the alternative to any of the foregoing, the at least one wireless beacon includes one or more of: an ultrasonic beacon or an infrared beacon.

In addition or in the alternative to any of the foregoing, the infrared beacon is emitted vertically and reflected by a spinning mirror that redirects the infrared beacon across a 360 sweep in a horizontal plane.

In addition or in the alternative to any of the foregoing, the first gaming device determines a distance to the first beacon device based on a one-way time of travel of an ultrasonic beacon from the first beacon device to the first gaming device.

In addition or in the alternative to any of the foregoing, the ultrasonic beacon is reflected by a conic reflector that directs the ultrasonic beacon omnidirectionally across a horizontal plane.

In addition or in the alternative to any of the foregoing, the at least one wireless beacon transmits a clock synchronization signal that facilitates determination of a distance from the first gaming object to the first beacon device and an orientation from the first gaming object to the first beacon device.

In addition or in the alternative to any of the foregoing, the first gaming device includes a plurality of motion sensors that generate motion data, wherein the first position and orientation data is generated further based on the motion data and wherein the motion sensors include at least one: accelerometer, gyrometer, magnetometer and wheel encoder corresponding to at least one wheel of the first gaming device.

In addition or in the alternative to any of the foregoing, the client device includes a camera configured to capture image data of the first game space, wherein the client device utilizes computer vision to generate tracking data associated with the first gaming device and the first beacon device and wherein the first position and orientation data is generated further based on the tracking data.

In addition or in the alternative to any of the foregoing, the first telemetry data includes impact data generated based on the motion data and responsive to one or more physical impacts to the first gaming object by the second gaming object during the real-time remote game play of the mixed-reality game between the first gaming object and the second gaming object and wherein the impact data is further based on detection of virtual impacts to the first gaming object responsive to the real-time remote game play of the mixed-reality game.

In addition or in the alternative to any of the foregoing, the first gaming device includes a base portion, an ejectable portion that is mechanically coupleable to the base portion and an ejection actuator, and wherein the ejection actuator operates to eject the ejectable portion from the base portion based on the impact data.

In addition or in the alternative to any of the foregoing, the client device includes a camera configured to capture image data of the first game space, wherein the client device generates the first mixed-reality display based on the captured image data.

In addition or in the alternative to any of the foregoing, the first gaming device includes a plurality of motion actuators for controlling motion of the first gaming device and at least one game play action device that produces other game play actions of the first gaming device that operate under control of commands generated by the client device.

In addition or in the alternative to any of the foregoing, the first gaming object operates in the first game space under control of the client device in one of a plurality of modes selected by the first player, wherein the plurality of modes include two or more of: player controlled game play, artificial intelligence (AI) assisted game play or AI controlled game play.

FIG. 1B is a pictorial block diagram of an example mixed-reality gaming system. In this example, a first player associated with client device 25-1 is engaging with in remote mixed-reality game play via the mixed reality gaming platform with a second player associated with client device 25-2. The first player uses client device 25-1 to control the gaming object 20-1 in their local (physical) gaming space 30-1 that includes beacon device 32-1. The second player uses client device 25-2 to control the gaming object 20-2 in their local (physical) gaming space 30-2 that include beacon device 32-2. Telemetry data 34-1 that, for example indicates a measured/estimated state of the gaming object 20-1 (e.g., it's position, orientation, its progress through one or more gaming actions, and/or other game states) is generated based on gaming device interactions with beacon device 32-1, based on the motion sensors of gaming device 20-1, further refinement by the client device 25-1 and/or based on other data that is collected, shared and analyzed by one or more components of the mixed-reality gaming system. This telemetry data 34-1 (and real-time updates thereof) reflecting the position orientation state are sent to the mixed reality gaming platform 10 along with the other actions of gaming object 20-1 to be included in the gaming data 36-2 sent to the client device 25-2. The client device 25-2 uses this data to control either a VR character or physical proxy 22-2 (meant to remotely correspond to the gaming object 20-1, but in the game space 30-2) which is reflected (e.g., either virtually or based on captured imagery of a physical proxy) in the mixed reality display 26-2 presented to the user of client device 25-2 to facilitate play of the mixed-reality game.

Reciprocally, Telemetry data 34-2 that, for example indicates a measured/estimated state of the gaming object 20-2 (e.g., it's position, orientation, its progress through one or more gaming actions, and/or other game states) is generated based on gaming device interactions with beacon device 32-2, based on the motion sensors of gaming device 20-2, further refinement by the client device 25-2 and or other data that is collected, shared and analyzed by one or more components of the mixed-reality gaming system. This telemetry data 34-2 (and real-time updates thereof) reflecting the position orientation state are sent to the mixed reality gaming platform 10 along with the other actions of gaming object 20-2 to be included in the gaming data 36-1 sent to the client device 25-1. The client device 25-1 uses this data to control either a VR character or physical proxy 22-1 (meant to remotely correspond to the gaming object 20-2, but in the game space 30-1) which is reflected (e.g., either virtually or based on captured imagery of a physical proxy) in the mixed reality display 26-1 presented to the user of client device 25-1 to facilitate play of the mixed-reality game. In this reciprocal fashion, actions (either physical or virtual) in the gaming spaces 30-1 and 30-2 can mimic one another so that each player, though remote from one another, can experience the same mixed-reality game as if their were in the same physical location.

FIG. 1C is a schematic block diagram of an example gaming object in a mixed-reality gaming system. The gaming object 20-i includes a network interface device 42 for communicating with client device 25-1 via one or more of the networks 15, a memory 46 that stores instructions such as software, firmware, utilities, an operating system, etc. and a processing unit 48 that includes one or more processors for executing these instructions.

In various examples, the gaming object 20-i further includes one or more beacon receivers 44 for receiving beacon signals from one or more beacon transmitters 35 included in the beacon device 32-i (which can also be referred to as a tower). In various examples, the beacon signals include an ultrasonic signal that is used to determine a distance to the beacon device 32-i a radio beacon for synchronizing closk signals and an infrared (IR) signal for determining an angle to the beacon device 32-i. The gaming object 20-i further includes motion actuators 52 such as wheels or treads that cause the motion of the gaming object 20-i based on commands and/or other data from the client device 25-i. Motion sensors 54 generate motion data that can used to further indicate the position and orientation of the gaming object 20-i as well as to help detect collisions with, and/or hits” from, other physical gaming objects during the course of the game play. While not expressly shown, the beacon device 32-i can further include a memory and processing system that executes operational instructions stored in the memory as software or firmware to perform one or more operations of the beacon device 32-i.

In various examples, the beacon device 32-i further includes a VR projector 37, that emits an optical projection of one or more virtual elements such as characters, non-player characters, objects, weapons and/or other VR enhancements to the corresponding physical game space that can be viewed and/or controller by any players in view if the game space, by one or more observers via their corresponding client device(s) and/or can be detected by cameras associated with one or more client devices 25-i that capture imagery of the game space. In various examples, the VR projector 37 can be implemented via a nano/pico/mini projector, a laser projector with an articulated mirror and/or other laser or light projecting device configured to project infrared and/or visual optical images relating to game play (e.g., visual features that are a portion of the mixed-reality game display and/or other virtual enhancements) upon the game space. While described above as a part of the beacon device 32-i, in various examples, such a projector could be implemented separately from the beacon device but nevertheless located in proximity to an associated physical game space—such as a table, floor or other surface, on a separate tower, platform or other supporting structure above the game space or attached to a client device 25 in proximity to the game space.

In various examples, the gaming object 20-i further includes one or more game play action devices 56 that facilitate game actions by the gaming object 20-i controlled by the client device 25-i such as drilling, sawing, flying, digging, catching, throwing, shooting, punching, pushing, jabbing, lifting, flipping, hitting, and/or other game action, etc. The ejection actuator 62 facilitates ejection of an ejectable portion of the gaming device 20-i from a base portion of the device. This ejection can be facilitated in order to represent loss of a game by the gaming object 20-I, via physical interaction with the gaming object and/or in conjunction with other game actions tied to the specific game being played. Interface devices 38 can include one or more speakers or other sound emitters, lights, a display screen or other user interface device that can accentuate game play via the mixed-reality display and/or otherwise provide feedback to the player. Power monitoring 60 monitors the available battery life which can be reported to the client device 25-i and/or indicated by one or more user interface devices 58. The device interface 63 can include an connector such as a plug, jack or other interface that provides an electrical, optical or other connection to a device such as a camera, smartphone or other client device, a network interface device, a measurement device or other sensor, an output device, an input device, a connectable game play action device, and/or other device that supports the operation of the gaming object 20-i in game play.

FIG. 1D is a schematic block diagram of an example ejection process of a gaming object in mixed-reality gaming system. The gaming object 20-i includes an ejectable portion 66 that has been coupled (e.g., by spring loading or other ejectable coupling mechanism) to the base portion 64. The ejectable portion 66 (which can also be referred to as a mech) can include one or more game play action devices 56 and/or portions thereof) that include mechanisms (which can also be referred to as weapons) that facilitate game actions by the gaming object 20-i controlled by the client device 25-i such as catching, throwing, shooting, punching, pushing, jabbing, lifting, hitting, firing, launching or other game action, etc. along with one or more additional components of the gaming object 20-i. The base portion 64 that includes (along with other components) a motion sensor 54, motion actuators 52 and an ejection actuator 62 (which can also be referred to as a mech ejector) that facilitates ejection of the ejectable portion 66 of the gaming device 20-i from the base portion 64. The example process shows the gaming object 20-i, before and after ejection of the ejectable portion 66. It should be noted that while a particular partitioning of gaming object components between the ejectable portion 66 and base portion 64 is presented, other partitionings are likewise possible in further examples.

FIG. 1E is a schematic block diagram of an example mixed-reality gaming system. In particular an example is shown that can be implemented in addition or the alternative to any of the foregoing examples presented in conjunction with FIGS. 1A-1D. In this color figure, software/firmware components are presented in blue, hardware components are presented in green, gray or orange and selected data flows/connections are represented in yellow. The hardware components include wheel motors, a Temari mech that includes a mech weapon and a weapon switch, red-green-blue (RGB) light emitting diodes (LEDs), a speaker, a weapon motor, a mech ejector, 2.4 GHz radios that includes a transmitter (TX) and receiver (RX) that operate via a BLE protocol and other network interfaces (I/Fs), an ultrasound transmitter and receiver, in infrared emitter and receiver, a 6-axis inertial measurement unit (IMU), wheel encoders, a magnetometer, a mech code reader, a weapon motor encoder, a battery level monitor, an IR mirror rotor and an IR mirror encoder.

The functionality of the embedded firmware (FW) in the gaming object 20-i includes a wheel controller, view controller, linear velocity controller, position controller, a set of soft limits, an impulse simulation, a LED driver, a sound driver, a mech weapon driver, a flash storage manager, application (APP) trajectory, a tower range function, a tower angle function, an angular velocity function, a linear acceleration function, a wheel velocity function, a magnetic heading function, a shock detection function, a mech reader function, a weapon cycle estimator, an APP control input function and a BLE stack. The functionality of the embedded firmware in the beacon device 32-i includes an ultrasound driver, a tower main controller, a ultrasound driver, an IR mirror controller, an LED controller, a clock synchronization (sync) function and a BLE stack.

The functionality of the embedded firmware in the client device 25-i includes an augmented reality function and associated visuals, a clock sync function, a BLE stack, a physical Temari driver, a tower driver, a virtual Temari simulation function, a Temari computer vision (CV) tracker, a tower CV tracker, a Temari state management function, a physical Temari remote control function, and an online multiplayer support function. The embedded firmware in the mixed-reality gaming platform 10 includes game play rules and functionality associate with each game process 14-i that includes client connection management for each of the client devices associated with the game process along with client state sync for each of the gaming objections (physical or virtual) and a Temari shock detection integration and validation function for analyzing hits and other impacts.

In accordance with one or more such examples that include many additional functions and features, that can be used in addition or in the alternative to any foregoing previous examples, the mixed-reality gaming system is again presented in conjunction with the remaining description that can be associated with the example of FIG. 1E. This example of the mixed-reality gaming system includes:
The Temari robots (i.e., gaming objects 20)—they include an array of sensors that provide partial measurements of the robot's pose relative to the localization reference system.
The localization reference system (i.e., the beacon devices 32) also serves as the reference for mapping the virtual game world to the physical local space)
The local controlling host simulation device (i.e., a client device 25) implementing the mixed-reality game, and also acting as a human interface device for manually issuing commands to the robot
Any remote game hosts (i.e., other client devices 25)—running the same mixed-reality game in lockstep, potentially relaying controls and localization data to and from their own local physical Temari robots as coordinated by the mixed-reality gaming platform 10.

In order for the robot to be integrated with the virtual game world as well as responding to local physical and virtual constraints with minimal latency, there are three functional loops that can run at all times:
The local Temari robot loop—local state estimation on the robot processing unit based on sensor input, decision making and executing those decisions by controlling any of the robots physical systems. This loop is helpful in maintaining good responsiveness of the robot, as the round trip for any pose estimation done on the host device is too long for the robot to properly react to that information.
The local host device loop—the local robot state estimate is sent to the host device game application via a radio link (the Temari uses the Bluetooth Low Energy protocol), where it's factored into the game simulation state, then a decision is made and encoded into a control packet which is transmitted back to the robot which then executes the game-issued commands in conjunction with the commands resulting from its own locally computed decisions. This is the loop that integrates the robot with the local game simulation of the client device 25. It allows for virtual constraints to be applied as well as for the robot to interact with virtual game element and display physical behaviors in response to those interactions—e.g. a virtual projectile fired from a virtual weapon can detect a hit with a physical Temari robot and then the robot can simulate a reaction impulse (by “acting” out a local control sequence to simulate the impact.)
The network loop—this integrates multiple game hosts, either on the same local network or remotely over the internet. The local state estimate of the robot is transmitted to its local host which then transmits it to the other hosts that are running the same game simulation. A remote host can use this information to display a virtual avatar of the originating Temari robot or control a local Temari robot to match the state of the originating robot, achieving remote presence of the originating robot.

In order for the game simulations running on different hosts to be kept in sync, there is a global reference time that all events on all the synchronized game simulations and the physical Temari's establish, maintain and embed into their communication. Each of the connection segments in the networked loop (the BLE link and the network link) use time synchronization mechanisms that continuously assess round trip latencies across the links and keep the clocks of the nodes in the loop referenced to a global timeline (with the reference being the server host's time.)

All three loops close at the robot's processing unit's level, with the robot state estimation being at the core of the system. The state of the Temari robot is estimated by the robot's local processing unit, by combining input from an array of sensors:
Ultrasound range detector relative to a central beacon (the tower)
Infrared-based estimation of the angle relative to the central beacon (the tower)
Wheel encoders-quadrature wheel encoders measure the current rotation rate and direction of each wheel independently
6-axis IMU (3-axis accelerometer+3-axis gyrometer) measures current linear accelerations and rates of rotation.
3-axis magnetometer obtains a magnetic yaw estimation in the geomagnetic frame of reference that is then translated into the frame of reference of the tower (this estimate optional, but can improve the stability of the orientation estimate when used).

All systems can make use of the robot's local clock, based on its internal 64-bit clock, locally used as such and also transmitted as a 32-bit clock to the client device, which in turn uses it to derive the game simulation global clock. The clock synchronization source is the tower, which broadcasts its own 64-bit timer to any Temari robots that are within reception range. Temari robots use the same radio as for their communication with the game host device (a multiprotocol radio that can time-slice between Bluetooth Low Energy and an alternative, lean protocol that is used for broadcasting the time signal from the tower, along additional synchronization data that is used in the computation of the local Temari robot estimates). The clock signal is transmitted at regular intervals, to make sure the Temari robot clocks remain synchronized despite non-negligible individual clock drifts. This same clock sync mechanism can be implemented over an alternative carrier (e.g. infrared), but it's cost effective for Temaris to reuse the BLE radio for this purpose since they already include it for communication to the game host device. The clock synchronization shares the same radio peripheral as the BLE stack on the main module. A time-slicing mechanism can be used that allows the system to claim idle time from the radio and use it to transmit clock synchronization info in the case of the tower or listen for broadcasts in the case of the vehicles. The entire timing flow relies on HW shortcuts for capturing a number of timer instances, synchronized with the radio interrupts, to avoid introducing extra jitter from SW interrupts. The synchronization system achieves sub-microsecond jitter, as low as 60 ns in optimal conditions and about 100 ns on average.

In addition to the outlined sensors used for pose estimation, Temari robots provide additional state data that is necessary for supporting the non-navigational game play features that the robot supports: active weapons inserts-“mechs” with encoders for weapon cycle estimation, warrior character recognition, battery level estimator, Temari vs Temari impact estimator, etc.

An ultrasound range estimator is a binary system, with an emitter on the tower and receivers in individual Temari robots. The system was from the beginning designed to be one way—no round trip/echoes involved, using an external, independent radio signaling path (so it relies on the tower-Temari clock synchronization system). The tower emitter provides bursts of 40 KHz ultrasound at regular intervals synchronized with the clock of the tower (which itself is broadcasted to the Temari units).

On the emitter side the main challenge was providing an unobstructed transmission path (the emitter is buried inside the tower) and achieving a high enough level of amplification. To achieve a strong pulse, the transducer is driven at 30V. That is achieved via a step up switching boost converter (from the 3.7V provided by the battery). The 40 KHz signal is provided by a PWM peripheral on the BLE module and the switching done via an H-bridge (a motor driver IC in the initial design). The pulses are synchronized with the master tower clock using a set of programmable hardware interrupts on the main module. The burst rate was 30 Hz initially, but it was reduced down to 20 Hz to cope with some challenging echoing/reverberating play spaces.

The Temari robot receiver consists of a 40 KHz ultrasonic transducer, whose output is amplified by a cascade of amplifying bandpass filters then thresholded by a hysteresis comparator to provide a square, binary representation of the signal. Slope-triggered interrupts on a digital IO pin capture the zero crossings of the receiver signal. The Temari robot clock is synchronized with the tower clock, and the tower bursts are emitted at regular intervals, meaning that both emission and reception can be related in the same temporal reference system. The offset between the start of the detected burst and the known emission time represents the one-way travel time for the ultrasonic signal, which is proportional to the distance traveled by the wavefront. Therefore, the distance is estimated based on the time of flight and the known speed of sound. The estimate is then filtered to remove noise caused by environment reflections or locally generated ultrasound and corrected for warping due to ultrasound path distortions in the system of access vents and internal deflectors housed in the top section of the Temari.

The ultrasound omni-receiver is housed within the top of the Temari, and there are multiple components in the way, especially for frontal wavefront access. The system can be designed to address these gaps with internal deflectors that “curve” the sound path around the internal obstructions that distort the sound path to some extent, but since these distortions are consistent with orientation, they can be compensated by a system that also has access to the orientation of the Temari relative to the tower emitter. The Temari receiver itself utilizes a filter/amplifier/ADC circuit. Since the omnidirectional pattern is achieved by squashing the output of a regular ultrasound transducer into a horizontal plane, this diminishes the output in any given direction greatly, even with relatively high driving voltages on the emitter (in themselves a challenge at the 40 KHz the system operates and with the cost of components targeted).

The Infrared Angle to tower Estimator provides a measurement of the direction from the tower to the Temari vehicle relative to a reference tower direction (the tower “North”). It is sub-degree accurate and can run at high update rates, however, to account for limited processing power on the Temari robots MCU (which handles radio communications as well as the navigation and control code) the frequency chosen for angle measurements was 30 Hz.

It is also a binary system, with an emitter on the tower and receivers in individual Temari robots. No round trip/echoes involved, using an external, independent radio signaling path (so it relies on the tower-Temari clock synchronization system). The tower emitter is a high power IR LED, with a relatively narrow beam angle. The IR is modulated at 40 KHz and driven from a PWM peripheral on the BLE module through a digital GPIO pin. The beam is emitted vertically and reflected 90 degrees off a spinning mirror that redirects it into a 360-degree sweep in the horizontal plane. The mirror rotor is driven by a DC motor whose speed is regulated based on data from an encoder on the rotor-the tower uses the same IR signal for the encoder, so that signal has to be demodulated before running it through a comparator, then digital GPIO, this pulse is used in FW to determine both the phase in the mirror cycle and the cycle duration. The system relies on the clock sync system, with additional IR-cycle measurements broadcast by the tower to compensate for the uncertainty introduced by the electromechanical rotating mirror system.

Once at steady state, the rotor controller maintains a uniform 30 Hz spin cycle, but since this is an electromechanical system there are limits to the consistency that can be achieved. Therefore, the duration of the previous IR spin cycle can be transmitted to the Temari robots, together with the timestamp of the zero angle crossing of the rotor.

The Temari robot receiver consists of a circular array of IR phototransistors that each cover a solid angle around the Temari, with some overlaps. Past an initial amplification stage through a transimpedance amplifier, the signal from all the IR receivers can be summed before being further amplified though a chain of bandpass filter amplifiers designed around a low cost small signal operational amplifier (op amp).

On the Temari receiver side, the moment the pulse from the tower is received (e.g., the middle of the received pulse is used, and the same is done on the tower IR rotor phase detection encoder) is directly correlated with the angular displacement of the vehicle relative to the tower. Taking the information about the start of the pulse (which is in fact most often an extrapolation from the last IR cycle, depending on the timing of the clock broadcast reception versus the time of IR pulse detection) and the predicted length of the IR cycle, both derived from the data broadcast by the tower together with the tower clock reference, the angle of the robot relative to the tower can be computed. Because at 30 Hz update rate the acceptable jitter is with the microsecond range for the desired angular accuracy, it is desirable for all the timing data to be acquired with no latency, therefore all the pulses trigger timer captures via direct hardware (HW) shortcuts, that way the timing data is not skewed by interrupt priorities (and the main module is already busy most of the time running the BLE stack).

Because in practice, most environments include stray reflections from surrounding objects, as well as potential background IR radiation (such as from sunlight or other devices like TV remotes), the IR signal undergoes a digital filtering step after the filtering-amplification stage in the HW circuit. This step takes into account the temporal and geometric constraints resulting from the operational characteristics of Temari vehicles (e.g., the angle rate of change has to be within a set limit, the change width of the IR pulse should be correlated with the change in ultrasound range, as well as with the history of the local estimated position after full sensor fusion).

Temari robots feature wheel encoders, custom designed incremental quadrature IR transmissive encoders that detect changes in wheel rotation and direction. The encoder discs are directly attached to the motor shafts and provide a number (e.g., 10 more or less) transitions per motor revolution, which translates to sub-millimeter accuracy at the wheel ground contact (and the minimum detectable linear displacement of the wheel contact). The signals from the individual tracks (two per wheel encoder, with a 90-degree phase offset) are captured via digital GPIOs with attached HW interrupts and processed using the robot's MCU. Using a differential drive model taking into account the Temari robot geometry, the data wheel encoders together are then used for deriving estimates of the robot's linear travel relative to a given reference in the past, estimates of the robot's yaw rate, yaw displacement relative to a past reference, as well as accurate estimates of the individual velocities of the wheels that are used by the robot's wheel controllers to regulate wheel angular velocities (used for accurate control of the robot's yaw and linear velocities, which is essential for accurately driving the robot to designated target points and for the self-imposed, simulated virtual constraints).

A six-axis IMU includes a 3-axis accelerometer and a 3-axis gyrometer, measuring current linear accelerations and rates of rotation on three separate axes. The Temari FW supports multiple MEMS IMUs. IMU communication is done via the I2C/TWI protocol, used for acquiring measurements and for controlling the settings and operation of the component.

The measurements for acceleration and rotation rates are fused in FW by an attitude and heading reference system to generate an orientation estimate, as a rotation quaternion. This estimate is relative to the start position of the robot and is related to the tower orientation via a process of initial yaw calibration that uses the IR and ultrasonic and the known geometry of the robot spinning about one of the wheels to estimate the mapping from start yaw space to tower space.

A 3-axis Magnetometer is used for deriving a magnetic heading estimation in the geomagnetic frame of reference that is then translated into the frame of reference of the tower (this estimate is optional, as there are multiple sources of but can improve the stability of the orientation estimate when used, as well as reduce/eliminate the need for the initial yaw calibration step). The magnetometer is also calibrated during the initial tower yaw offset computation, for both hard and soft iron.

The Onboard Pose Estimation Process includes an orientation computation and position computation, the orientation computation uses several sensor-derived measurements. The wheel encoders are used to derive a yaw displacement relative to a reference time in the past using a differential drive model for the Temari. This estimate suffers from errors resulting from tire slip, but that in itself is used by the traction/stability control algorithm, which basically tracks the disparity between this estimate for yaw rate and the AHRS yaw rate estimate (which is not affected by slip). The magnitude of the disparity indicates a larger degree of wheel slip, which can be used by the yaw and linear speed controller to minimize drifting and skidding, by reducing individual wheel motor throttles to minimize slip and increase traction. This allows for optimization of turning and acceleration/deceleration.

The IMU accelerometer and gyroscope are used to compute a full 3D orientation using an AHRS algorithm. Since there's no absolute reference for yaw, a differential yaw estimate from the position estimate displacement (similar to an orientation estimate used by GPS) is used. This is a differential absolute yaw measurement, so it uses the movement of Temari robot in order for a sample to be acquired. A magnetic heading, computed from magnetometer measurements. This is a continuous absolute measurement for yaw.

Except for the magnetic heading these orientation estimates are computed in the local space for the Temari robot. All the estimates are transformed into tower space using a local to tower yaw offset that is computed during the initial yaw calibration and then updated via the differential method using a Kalman filter (e.g., an extended Kalman Filter) that takes the position differential yaw estimate samples, with a measurement error assessed from the short term disparity between the yaw displacement from AHRS and the position differential yaw displacement for the same time interval.

A map of the magnetic field of the playspace can be built with samples acquired whenever there is a high confidence pose estimate available that can be associated with a measurement of the magnetic field at that point. During the initial calibration, the vehicle can be controlled to complete a full circle pivoting around one wheel; this has the ultrasound transducer moving in a circle, whose max and min range from a vector pointing directly away from the tower. This with the vehicle angular displacement relative to the tower can be used to derive a heading that is accurate enough to start driving and refine the estimate with the differential system, which uses a Kalman filter to estimate the yaw offset.

This provides quick and robust convergence, with a shortcoming being that any yaw perturbations that are not captured by the inertial AHRS while the unit is either pinned in place or spinning beyond the saturation limit of the gyroscope cannot be corrected and it takes a few samples of the position differential yaw for the offset to be corrected, which leaves a short time frame during which the vehicle may use an inaccurate local yaw estimate. This estimate can be corrected by the host game application (e.g., the game application) using the computer vision based Temari tracker, when the unit is in view of the device's camera. Ultimately the magnetic heading can also be used.

When all is put together the yaw estimate tends to be very stable, as the situations when all the measurement sources fail are very rare. When the yaw estimate error is large and depending on the current location of the unit, action can be taken, such as triggering a new yaw calibration or requiring a game play intervention from the player that has them pointing at the unit (which enables acquiring a CV rotation estimate that can then be used to correct the local Temari estimate.)

The position computation also uses several sensor-derived measurements:
The angular displacement of the Temari robot relative to the tower orientation frame of reference (the “tower North”) computed using the IR sensors.
The ultrasound-measured range from the tower.
The encoder-derived linear displacement in the initial calibration AHRS space.
The fused orientation estimate, computed separately.
The acceleration measurements from the IMU.

The measurements are fused/combined by an extended Kalman filter running on the robot's MCU at 30 Hz. The measurement errors for individual sensors are continuously assessed by directly statistically estimating the quality of the signals. This enables quick convergence and very good accuracy. This does not mean the estimate is without flaws, as there are cases where all sources of estimation are either unavailable or significantly perturbed, most typically two units butting up against each other and occluding each other's IR receivers while also spinning their wheels.

In addition to the onboard pose estimation by the gaming object 20, the game simulation host (e.g., client device 25) also runs computer vision (CV) trackers for the Temari robots and the tower. The tower CV tracker is used to map the game world space to the physical play space (with the tower being the origin of both reference frames). It is a refinement tracker, it uses the device AR localization priors to then search for the tower in physical space, using the floor plane and initial AR localization with a set of handpicked world space oriented gradients. This is far more accurate than the initially attempted solution based on a generic planar target tracker which had severe limitations as to the distances it could track from, was cumbersome and impacted the play experience negatively.

The Temari CV tracker provides pixel-accurate position estimates, which can assist displaying virtual augmentations on top of the Temari robots to visually integrate them with the game world and mechanics. The system takes advantage of the embedded telemetry made available to the game and the existing mobile device localization. It uses a lean custom definition of the Temari model, a collection of manually defined gradients selected for their specificity. As opposed to typical trackers, this is a system that searches the target in world space rather than attempting to match screen space descriptors or micro patches to sets of descriptors in the model. This avoids the necessity of multi resolution tracking and also allows for tight optimization of the search space. The same priors are also used to discriminate between different units engaged in game play. As opposed to the previous implementation of the tracker, the refinement tracker does not use color tracking or relies on blob matching and alignment of the Temari lights, which are now freed for use in game play and vehicle customization.

While the telemetry data generated by the pose estimation module is used by the mixed-realty game, there is additional data that the robot acquires, processes, transmits and acts upon that is not part of pose estimation but provides functionality supporting various game play mechanics in the host game simulation. For example, the Temari robots can be semi-autonomous intelligent vehicles in the game, closely interacting and cooperating with their pilots/handlers/players (which can also be referred to as “warriors”). The warriors are physically represented by small posable action figures that capture the unique visual attributes of the rider, their class (fighting role) and team affiliation. The warrior mini-figures can uniquely associated and mounted on a mech, which is a plug and play active weapon plus armor module that is loaded (e.g., coupled/connected) into the Temari vehicle. The vehicle has a communication interface with a loaded mech that allows the robot to get information about the mech loaded and to control its active function (e.g. swing a hammer or thrust a spear). The FW can read a unique code for an inserted mech and relay that to the game host simulation, enabling particular behaviors and game play features tied to the loaded character.

The active function of the mech weapon(s) can be supported by a dedicated motor inside the Temari robot which connects to the mech drive via an internal transmission and a slip clutch at the interface between the vehicle and the mech. There are multiple possible mechanisms for the mechs that transform the rotational motion transmitted at the clutch into thrusting, swinging, pincer or spinning weapon movements. These are tied to the class (fighting role) of the warrior. The mech drive motor has a single-track encoder attached that allows the estimation of the weapon cycle phase, and the mech itself contains a trigger switch that signals a set point in the weapon cycle. Put together this information is used to determine the current position of the weapon, as well as for driving the weapon motor to put the weapon in specific game play states (such as holding, primed to fire, arming) that support various game play mechanics and other game play actions.

The mech receiver can be spring loaded and the mech can be ejected either manually by pushing a large button on the back of the Temari robot, or from software, via an actuation mechanism coupled to running the mech active function motor in reverse (to save on costs.)

The ejection function of the mech is used in game play to represent a finishing blow from the opponent or other game conditions. The physical eject button can be hit by another physical opponent, while the software triggered eject allows a virtual opponent or virtual avatar of a physical opponent to do the same. The mech being ejected is scored in game as a knockout (KO).

The mixed-reality gaming system is able to detect two robots colliding, as that's the basis for some of the fighting/battle mechanics such as ramming the opponent, as well as to reliably tell when a weapon hit connected. There may be no dedicated sensors for either, the information is derived from a generic shock detection algorithm that runs on the FW using the measured linear accelerations, and centralization of the received impacts with their global timestamps, weapon phase at those timestamps, relative position and orientation of the robots as well as pre-stored/scanned definitions of the mechs in play. Taken together and related to the global timeline the algorithm, running on the server game simulation host can aggregate all the data coming from the players and decide what has hit what. This same mechanism can be emulated by virtual Temaris, so there's parity between physical and virtual combatants.

The seamless blending of the virtual and physical realities is the foundation of the mi-reality gaming system. It is desirable for the robot to display reactions to things that are happening in the virtual game world (that is communicated visually to the player via Augmented Reality). The robot FW implements the ability to physically simulate the effects of an impact in the virtual world, so the illusion is convincing. E.g. when the robot is hit by the shockwave of an enemy missile exploding nearby (or other virtual weapon impact) it can be jerked away from the explosion. This is accomplished by using the robots active wheel drive controls, the robots are literally acting out the impulse, and the fine degree of control and responsiveness of the driving system allows for the simulation to appear realistic, although there is no external physical force acting upon the robot. Much like a stuntman's performance in a Hollywood action movie, the impact is mimed. This is also used to exaggerate some of the physical impacts between Temaris, for greater dramatic effect.

The mixed-reality gaming system operates in the game space (which can be referred to as an arena) with virtual (“Soft”) Arena Limits. In various examples, Temari game play occurs in a defined circular play area around the tower. The area radius is chosen into playspace (e.g., game space) sizes typically available in most households. Since it is desirable for a player to not have to be concerned with respecting the game play space boundaries (and not run into obstacles that may lie outside it that can interfere with game play or accidentally drive the robot into the tower, which is also on the floor in the center of the playspace) a system of virtual arena constraints can be implemented that automatically keep the robot within the safe areas of the playspace, by automatically adjusting the robot's driving commands in the embedded FW to respect the boundaries that are set. The result is that the robot smoothly adjusts user input to curve its path along the boundaries (which are also visually represented in the augmented reality game display.)

This system can be implemented on the embedded side to allow for tight response to the boundary constraints, as the latency of the BLE link with the host could be too large to properly cope with the speed the robot is going at (which is very large relative to the scale of the robot and the playspace (e.g., game space).) It relies on the local state estimate and the accuracy and responsiveness of the controllers that govern Temari wheel motion (which can run at 200 Hz.)

With the same goal of blending the physical and virtual realities, the Temari robot can include its own onboard programmable color LEDs that it can use to signal its damage state or highlight impacts (by flashing its light in sync with the impact). Coupled with the inclusion of a speaker and a sound driver in FW, this adds another layer of interaction between the virtual and physical, as well as helps to visually and audibly communicate the personality of the warriors/mechs.

In various examples, the Temari game host (e.g., client device 25) implements a virtual emulation of the Temari robots, driven by a physics simulation of the robot and running the same algorithms for control and sensor data flows as the physical hardware robot. This allows the game play code of the gaming application to treat Temari robots as abstract entities, with no distinction in game play between a physical and virtual Temaris. Virtual Temaris emulate all aspects of physical Temaris, including the visuals, mech operation, mech ejections, etc.

This makes virtual Temaris usable as both virtual game artificial intelligence (AI) controlled enemies that a player operating physical Temari can battle as virtual proxies in mixed reality battles, as well as local stand-ins of remote physical Temari robots operated by a remote human opponent.

In addition to the virtual Temari emulation, the game allows for the possibility of players operating a remote physical Temari, in which case the player locally operates a virtual Temari whose state is kept in sync with that of the remote operated Temari, which physical Temari is forwarded a copy of all the input from the player that would normally sent to a local physical Temari. To provide a responsive experience the local virtual Temari immediately simulates the result of the player input, then waits for the roundtrip state update from the remote physical Temari executing the forwarded commands and corrects its virtual local state accordingly if the simulation has diverged from the remote physical simulation.

In further examples, the mixed reality gaming system can facilitate sharing the experience by selectively adding spectators to a match (e.g., users that can connect to the game and explore the game world in augmented reality, witnessing the games as they happen and even influencing the outcome via gifts and perks they can award to their favorite.

The ability to share a mixed-reality gaming experience remotely can take several different modes which are selectable by each player before beginning a multiplayer game:
Local Physical vs Remote Virtual Mode—Local player playing physical Temari against remote player playing a virtual Temari—the local player sees a virtual Temari opponent whose local state is synchronized with that of the virtual remote Temari.
Local Physical vs Remote Physical Mode—Local player playing physical Temari against remote player playing a physical Temari—the local player sees a virtual representation of the remote opponent's physical Temari.
Local Virtual vs Remote Physical Mode—Local player playing virtual Temari against remote player playing physical Temari, the local player sees a virtual representation of the remote opponent's physical Temari.
Remote Physical vs Remote Physical Mode—Local player operating a remote physical Temari sees a virtual representation kept in sync with the remote physical. Both physical Temari robots practically belong to the opponent player, and this is an opportunity to play a physical robot without owning it. This is also the mechanism that allows the set up studio games—essentially a game show where contestants compete remotely in invite-based events using physical Temari units set up in our own studio. Using the Spectator system multiple angles can be offered of the physical battle between the robots complete with virtual augmentations. Spectators can influence the outcome of studio games via gifts and perks.

FIG. 1F is a pictorial diagram of example components of a mixed-reality gaming system. In particular, examples of beacon device 32-i and gaming objects 20-i and 20-j (having ejectable portions coupled to the base portions) are presented along with a carrying case 75.

FIGS. 1G-FIG. 1I are a pictorial diagrams of example gaming objects of a mixed-reality gaming system. FIG. 1G corresponds to an example of gaming object having a game play action device configured to interact with another gaming object in the mixed-reality game as a catcher that performs corresponding game actions of catching blows, weapons and/or other attacks from other game objects/characters. FIG. 1H corresponds to an example of gaming object a game play action device configured to interact with another gaming object in the mixed-reality game as a defender that performs corresponding game actions to defend against collisions and/or attacks from other game objects/characters. FIG. 1I corresponds to an example of gaming object a game play action device configured to interact with another gaming object in the mixed-reality game as an attacker that performs corresponding game actions to attack other game objects/characters.

FIGS. 1J-FIG. 1N are a pictorial diagrams of example screen displays of a mixed-reality gaming system. In these examples, screen displays of a client device of a local player are presented. In the screen display 26-3 of FIG. 1J, the player has scanned and registered his/her gaming object 20-1 for battle with a remote player. The player has also scanned and registered the beacon device 32-1 that will also be placed in the local player's game space as well as a second gaming device 22-1 that will serve as a physical proxy in the player's game space that reproduces, in real-time, the actions of the remote players gaming object during a remote online battle instance of the mixed-reality multiplayer game.

In the screen display 26-4 of FIG. 1K, a second round of game play (e.g., battle) is about to begin. This mixed-reality display shows a portion of a tabletop or floor that serves as game space 30-1 as well as the physical objects, gaming object 20-1, beacon device 32-1 and physical proxy 22-1 for the gaming object/virtual character of a remote player. This imagery of the physical scene has been augmented by other imagery that includes a virtual boundary 31 of the game space, round number and timing, character names, as well as other augmentations. In the screen display 26-5 of FIG. 1L, the second round of game play is ongoing. In addition to showing the real-time gaming object 20-1, beacon device 32-1 and physical proxy 22-1 (updated as to position, orientation and other gaming actions based on telemetry data from the gaming object/virtual character of the remote player), this imagery of the physical scene of game space 30-1 has been augmented by other imagery that includes command prompts 70 and 72 that can be interacted with by the local player and as part of the game play.

In the screen display 26-6 of FIG. IL, a third round of game play is ongoing. In addition to showing the real-time gaming object 20-1, beacon device 32-1 and physical proxy 22-1 (updated as to position, orientation and other gaming actions based on telemetry data from the gaming object/virtual character of the remote player), this imagery of the physical scene of game space 30-1 has been augmented by other imagery that includes augmentations to the image of physical proxy 22-1 to indicate the implementation of an energy shield and the augmentation of gaming object 20-1 to correspond to its selection and firing (by interaction with one of the command prompts 72) of a virtual weapon 76 corresponding to digital, rather than physical combat. It should be noted that the imagery of gaming object 20-1 is partially obscured due to the presence of command prompts 70.

In the screen display 26-7 of FIG. 1L, the game play has concluded by the defeat of the remote player. The physical proxy 21-1 has ejected its mech weapon and the imagery of the physical scene of game space 30-1 has been augmented by other imagery that indicates by the player's defeat.

In the screen display 26-8 of FIG. 10, an active observer of the game has introduced an additional challenge to the game, via commands executed by the observer's client device 25-i and transmitted to client devices 25-1 and 25-2 associated with the players/users that control the two robot combatants engaged in the game. In the example shown, the observer has introduced a virtual element 39-0 corresponding to a virtual box containing killer stinging wasps that has been parachuted (e.g., virtually) into the game space as represented by the corresponding mixed-reality display. Once released from the box due to a virtual impact by either the virtual ground of the game space, the physical proxy 22-1 or gaming object 20-1, the virtual killer wasps operate autonomously via AI control and/or commands from the active observer, to attack the robots potentially causing stings that (like hits) degrade the health of the affected robots in the game.

FIG. 1P is a pictorial diagram of an example game space. In particular, an image of a game space 30-1 is presented that includes a VR projector 37 that is supported above the game space 30-1 by structural supports 33. In operation, the VR projector 37 emits an optical projection of various virtual elements upon the second gaming space. These virtual elements include virtual boundary 31 and other virtual elements 39 such as tower enhancement 39-1, virtual enhancement 39-2 to gaming object 20-1, virtual enhancement 39-3 to physical proxy 22-1, etc. These virtual elements are 39 are visible to players in proximity to the game space 20-1 and can be captured by the camera of the client device.

FIG. 1Q is a flow diagram of an example method for use with a mixed-reality gaming system and particularly any of the functions, features and examples presented in conjunction with FIGS. 1A-1O.

Step 85-01 includes switching on gaming object(s). Step 85-02 includes selecting character(s) and playstyle—from a plurality of different characters and/or playstyles. Step 85-03 includes placing gaming object(s) and a beacon device in a physical gaming space. Step 85-04 includes selecting/customizing the game mode—from one of a plurality of game modes. Step 85-05 includes engaging in game play.

FIG. 1R is a flow diagram of an example method for use with a client device and/or mixed reality gaming platform of mixed-reality gaming system and/or a game process for use therewith and further any of the functions, features and examples presented in conjunction with FIGS. 1A-1Q.

Step 90-01 includes receiving, via the network interface, first telemetry data corresponding to a first gaming object in a first game space, wherein the first gaming object is a first physical object that operates in the first game space under control of a first client device of a first player and wherein the first game space is a physical space in proximity to the first client device. Step 90-02 includes generating first gaming data corresponding to a mixed-reality game, the first gaming data based on a positioning of the first gaming object in the mixed-reality game. Step 90-03 includes sending the first gaming data to a second client device of a second player controlling a second gaming object in the mixed-reality game to facilitate real-time remote game play of the mixed-reality game between the first gaming object and the second gaming object.

In addition or in the alternative to any of the foregoing, the second gaming object is a second physical object that operates in a second game space under control of the second client device and wherein the second game space is a physical space in proximity to the second client device and remote from the first game space.

In addition or in the alternative to any of the foregoing, the first telemetry data includes first position and orientation data corresponding to the positioning of the first gaming object relative to a first beacon device in the first game space; the first gaming data facilitates real-time game play of the mixed-reality game between the first gaming object and the second gaming object based on a first mixed-reality display that includes a first virtual reality representation as a proxy for the first gaming object and is presented to the second player via the second client device; and the first mixed reality display positions and orients the first virtual reality representation in the second game space based on the first position and orientation data.

In addition or in the alternative to any of the foregoing, the operations of the at least one game process further include:
receiving, via the network interface, second telemetry data corresponding to the second gaming object in the second game space;
generating second gaming data corresponding to the mixed-reality game, the second gaming data representing the second gaming object as a second virtual reality representation as a proxy for the second gaming object; and
sending the second gaming data to the first client device to facilitate the real-time remote game play of the mixed-reality game between the first gaming object and the second gaming object;
wherein the second telemetry data includes second position and orientation data corresponding to the second gaming object relative to a second beacon device in the second game space;
wherein the second gaming data facilitates the real-time game play of the mixed-reality game between the first gaming object and the second gaming object based on a second mixed-reality display that includes a second virtual reality representation as a proxy for the second gaming object and is presented to the first player via the first client device;
wherein the second mixed reality display positions and orients the second virtual reality representation in the first game space based on the second position and orientation data.

In addition or in the alternative to any of the foregoing, the operations of the at least one game process further include:
receiving, via the network interface, first action data corresponding to other game play actions of the first gaming object, wherein the first gaming data and the first mixed-reality display are further generated to reflect the other game play actions of the first gaming object; and
receiving, via the network interface, second action data corresponding to other game play actions of the second gaming object, wherein the second gaming data and the second mixed-reality display are further generated to reflect the other game play actions of the first gaming object.

In addition or in the alternative to any of the foregoing, the second mixed-reality display includes a visual enhancement of the first gaming object that is based on augmented reality.

In addition or in the alternative to any of the foregoing, the first mixed-reality display includes a visual enhancement of the second gaming object that is based on augmented reality.

In addition or in the alternative to any of the foregoing, the first telemetry data includes position and orientation data corresponding to the positioning of the first gaming object relative to a first beacon device in the first game space; wherein the first gaming data facilitates real-time game play of the mixed-reality game between the first gaming object and the second gaming object based a first physical proxy for the first gaming object in the second game space and based on a first mixed-reality display that is presented to the second player via the second client device; and wherein the second gaming data facilitates orientation of the first physical proxy in the second game space based on the position and orientation data.

In addition or in the alternative to any of the foregoing, the first beacon device includes at least one beacon transmitter configured to transmit at least one wireless beacon and the first gaming object includes at least one beacon receiver and wherein the first position and orientation data is generated based on reception of the at least one beacon via the at least one beacon receiver.

In addition or in the alternative to any of the foregoing, a projector emits an optical projection of one or more virtual elements associated with the first mixed-reality display upon the second gaming space.

In addition or in the alternative to any of the foregoing, an additional client device operates as an observer of the mixed-reality game, reproducing mixed-reality game displays on the display of the additional client device.

In addition or in the alternative to any of the foregoing, the additional client device operates as a passive observer allowing users of the additional client device to observe the game play without any interaction.

In addition or in the alternative to any of the foregoing, the additional client device operates as an active observer allowing users of the additional client device to control one or more virtual elements of the game play without any interaction.

In addition or in the alternative to any of the foregoing, the at least one wireless beacon includes one or more of: an ultrasonic beacon or an infrared beacon.

In addition or in the alternative to any of the foregoing, the infrared beacon is emitted vertically and reflected by a spinning mirror that redirects the infrared beacon across a 360 sweep in a horizontal plane.

In addition or in the alternative to any of the foregoing, the first gaming device determines a distance to the first beacon device based on a one-way time of travel of an ultrasonic beacon from the first beacon device to the first gaming device.

In addition or in the alternative to any of the foregoing, the ultrasonic beacon is reflected by a conic reflector that directs the ultrasonic beacon omnidirectionally across a horizontal plane.

In addition or in the alternative to any of the foregoing, the at least one wireless beacon transmits a clock synchronization signal that facilitates determination of a distance from the first gaming object to the first beacon device and an orientation from the first gaming object to the first beacon device.

In addition or in the alternative to any of the foregoing, the first gaming device includes a plurality of motion sensors that generate motion data, wherein the first position and orientation data is generated further based on the motion data and wherein the motion sensors include at least one: accelerometer, gyrometer, magnetometer and wheel encoder corresponding to at least one wheel of the first gaming device.

In addition or in the alternative to any of the foregoing, the first client device includes a camera configured to capture image data of the first game space, wherein the first client device utilizes computer vision to generate tracking data associated with the first gaming device and the first beacon device and wherein the first position and orientation data is generated further based on the tracking data.

In addition or in the alternative to any of the foregoing, the first gaming data includes impact data generated based on the motion data and responsive to one or more physical impacts to the first gaming object by the second gaming object during the real-time remote game play of the mixed-reality game between the first gaming object and the second gaming object and wherein the hits data is further based on detection of virtual impacts to the first gaming object responsive to the real-time remote game play of the mixed-reality game.

In addition or in the alternative to any of the foregoing, the first gaming device includes a base portion, an ejectable portion that is mechanically coupleable to the base portion and an ejection actuator, and wherein the ejection actuator operates to eject the ejectable portion from the base portion based on the impact data.

In addition or in the alternative to any of the foregoing, the first client device includes a camera configured to capture image data of the first game space, wherein the first client device generates the first mixed-reality display based on the captured image data.

In addition or in the alternative to any of the foregoing, the first gaming device includes a plurality of motion actuators for controlling motion of the first gaming device and at least one game play action device that produces other game play actions of the first gaming device that operate under control of commands generated by the first client device.

In addition or in the alternative to any of the foregoing, the first gaming object operates in the first game space under control of the first client device in one of a plurality of modes selected by the first player, wherein the plurality of modes include two or more of: player controlled game play, artificial intelligence (AI) assisted game play or AI controlled game play.

FIG. 1S is a flow diagram of an example method for use with a mixed-reality gaming system and/or a game application for use therewith and further any of the functions, features and examples presented in conjunction with FIGS. 1A-1R.

Step 95-01 includes generating first telemetry data corresponding to a first gaming object in a first game space, wherein the first gaming object is a first physical object that operates in the first game space under control of the client device based on interactions with a first player and wherein the first game space is a physical space in proximity to the client device. Step 95-02 includes sending (e.g., via a network and/or via a mixed-reality gaming platform) the first telemetry data to an other client device of a second player controlling a second gaming object in the mixed-reality game along with (and/or to support the generation of) first gaming data that is sent to the other client device to facilitate real-time remote game play of the mixed-reality game between the first gaming object and the second gaming object.

In addition or in the alternative to any of the foregoing, the second gaming object is a second physical object that operates in a second game space under control of the other client device and wherein the second game space is a physical space in proximity to the other client device and remote from the first game space.

In addition or in the alternative to any of the foregoing, the first telemetry data includes first position and orientation data corresponding to the positioning of the first gaming object relative to a first beacon device in the first game space; wherein the first gaming data facilitates real-time game play of the mixed-reality game between the first gaming object and the second gaming object based on a first mixed-reality display that includes a first virtual reality representation as a proxy for the first gaming object and is presented to the second player via the other client device; and wherein the first mixed reality display positions and orients the first virtual reality representation in the second game space based on the first position and orientation data.

In addition or in the alternative to any of the foregoing, the operations of the at least one game application further include:
receiving second gaming data corresponding to the mixed-reality game that is generated based on second telemetry data corresponding to the second gaming object in the second game space, the second gaming data representing the second gaming object as a second virtual reality representation as a proxy for the second gaming object, wherein the second telemetry data includes second position and orientation data corresponding to the second gaming object relative to a second beacon device in the second game space; and
generating a second mixed-reality display presented to the first player that includes a second virtual reality representation as a proxy for the second gaming object and is via the client device, wherein the second mixed reality display positions and orients the second virtual reality representation in the first game space based on the second position and orientation data.

In addition or in the alternative to any of the foregoing, the first telemetry data includes first action data corresponding to other game play actions of the first gaming object, wherein the first telemetry data and the first mixed-reality display are further generated to reflect the other game play and the second gaming data includes second action data corresponding to other game play actions of the second gaming object, and wherein the second gaming data and the second mixed-reality display are further generated to reflect the other game play actions of the first gaming object.

In addition or in the alternative to any of the foregoing, the second mixed-reality display includes a visual enhancement of the first gaming object that is based on augmented reality.

In addition or in the alternative to any of the foregoing, the first mixed-reality display includes a visual enhancement of the second gaming object that is based on augmented reality.

In addition or in the alternative to any of the foregoing, the first telemetry data includes position and orientation data corresponding to the positioning of the first gaming object relative to a first beacon device in the first game space; wherein the first gaming data facilitates real-time game play of the mixed-reality game between the first gaming object and the second gaming object based a first physical proxy for the first gaming object in the second game space and based on a first mixed-reality display that is presented to the second player via the other client device; and wherein the second gaming data facilitates orientation of the first physical proxy in the second game space based on the position and orientation data.

In addition or in the alternative to any of the foregoing, the first beacon device includes at least one beacon transmitter configured to transmit at least one wireless beacon and the first gaming object includes at least one beacon receiver and wherein the first position and orientation data is generated based on reception of the at least one beacon via the at least one beacon receiver.

In addition or in the alternative to any of the foregoing, the at least one wireless beacon includes one or more of: an ultrasonic beacon or an infrared beacon.

In addition or in the alternative to any of the foregoing, the infrared beacon is emitted vertically and reflected by a spinning mirror that redirects the infrared beacon across a 360 sweep in a horizontal plane.

In addition or in the alternative to any of the foregoing, the ultrasonic beacon is reflected by a conic reflector that directs the ultrasonic beacon omnidirectionally across a horizontal plane.

In addition or in the alternative to any of the foregoing, the at least one wireless beacon transmits a clock synchronization signal that facilitates determination of a distance from the first gaming object to the first beacon device and an orientation from the first gaming object to the first beacon device.

In addition or in the alternative to any of the foregoing, the first beacon device includes a projector that emits an optical projection of one or more virtual elements upon the gaming space.

In addition or in the alternative to any of the foregoing, an additional client device operate as an observer of the mixed-reality game, reproducing mixed-reality game displays on the display of the additional client device.

In addition or in the alternative to any of the foregoing, the additional client device operates as a passive observer allowing users of the additional client device to observe the game play without any interaction.

In addition or in the alternative to any of the foregoing, the additional client device operates as an active observer allowing users of the additional client device to control one or more virtual elements of the game play without any interaction.

In addition or in the alternative to any of the foregoing, the first gaming device determines a distance to the first beacon device based on a one-way time of travel of a ultrasonic beacon from the first beacon device to the first gaming device.

In addition or in the alternative to any of the foregoing, the first gaming device includes a plurality of motion sensors that generate motion data, wherein the first position and orientation data is generated further based on the motion data and wherein the motion sensors include at least one: accelerometer, gyrometer, magnetometer and wheel encoder corresponding to at least one wheel of the first gaming device.

In addition or in the alternative to any of the foregoing, the client device includes a camera configured to capture image data of the first game space, wherein the client device utilizes computer vision to generate tracking data associated with the first gaming device and the first beacon device and wherein the first position and orientation data is generated further based on the tracking data.

In addition or in the alternative to any of the foregoing, the first telemetry data includes impact data generated based on the motion data and responsive to one or more physical impacts to the first gaming object by the second gaming object during the real-time remote game play of the mixed-reality game between the first gaming object and the second gaming object and wherein the impact data is further based on detection of virtual impacts to the first gaming object responsive to the real-time remote game play of the mixed-reality game.

In addition or in the alternative to any of the foregoing, the first gaming device includes a base portion, an ejectable portion that is mechanically coupleable to the base portion and an ejection actuator, and wherein the ejection actuator operates to eject the ejectable portion from the base portion based on the impact data.

In addition or in the alternative to any of the foregoing, the client device includes a camera configured to capture image data of the first game space, wherein the client device generates the first mixed-reality display based on the captured image data.

In addition or in the alternative to any of the foregoing, the first gaming device includes a plurality of motion actuators for controlling motion of the first gaming device and at least one game play action device that produces other game play actions of the first gaming device that operate under control of commands generated by the client device.

In addition or in the alternative to any of the foregoing, the first gaming object operates in the first game space under control of the client device in one of a plurality of modes selected by the first player, wherein the plurality of modes include two or more of: player controlled game play, artificial intelligence (AI) assisted game play or AI controlled game play.

FIGS. 2A through 2E are schematic block diagram of embodiments of computing entities that form at least part of an improved computer technology. In particular, these computing entities can be used to implement the property maintenance platform 30, the client devices 20 and/or 25, and/or the property systems 40.

FIG. 2A is schematic block diagram of an embodiment of a computing entity 110 that includes a computing device 120 (e.g., one or more of the embodiments of FIGS. 2F-2L). A computing device may function as a user computing device, a server, a system computing device, a data storage device, a data security device, a networking device, a user access device, a cell phone, a tablet, a laptop, a printer, a game console, a satellite control box, a cable box, etc.

FIG. 2B is schematic block diagram of an embodiment of a computing entity 110 that includes two or more computing devices 120 (e.g., two or more from any combination of the embodiments of FIGS. 2F-2L). The computing devices 120 perform the functions of a computing entity in a peer processing manner (e.g., coordinate together to perform the functions), in a master-slave manner (e.g., one computing device coordinates and the other support it), and/or in another manner.

FIG. 2C is schematic block diagram of an embodiment of a computing entity 110 that includes a network of computing devices 120 (e.g., two or more from any combination of the embodiments of FIGS. 2F-2L). The computing devices are coupled together via one or more network connections (e.g., WAN, LAN, cellular data, WLAN, etc.) and perform the functions of the computing entity.

FIG. 2D is schematic block diagram of an embodiment of a computing entity 110 that includes a primary computing device (e.g., any one of the computing devices of FIGS. 2F-2L), an interface device (e.g., a network connection), and a network of computing devices 120 (e.g., one or more from any combination of the embodiments of FIGS. 2F-2L). The primary computing device utilizes the other computing devices as co-processors to execute one or more the functions of the computing entity, as storage for data, for other data processing functions, and/or storage purposes.

FIG. 2E is schematic block diagram of an embodiment of a computing entity 110 that includes a primary computing device (e.g., any one of the computing devices of FIGS. 2F-2L), an interface device (e.g., a network connection) 122, and a network of computing resources 124 (e.g., two or more resources from any combination of the embodiments of FIGS. 2F-2L). The primary computing device utilizes the computing resources as co-processors to execute one or more the functions of the computing entity, as storage for data, for other data processing functions, and/or storage purposes.

FIGS. 2F-2L are schematic block diagram of embodiments of computing devices that form at least a portion of a computing entity. FIG. 2F is a schematic block diagram of an embodiment of a computing device 120 that includes a plurality of computing resources. The computing resources, which form a computing core, include one or more core control modules 130, one or more processing modules 132, one or more main memories 136, a read only memory (ROM) 134 for a boot up sequence, cache memory 138, one or more video graphics processing modules 140, one or more displays 142 (optional), an Input-Output (I/O) peripheral control module 144, an I/O interface module 146 (which could be omitted if direct connect IO is implemented), one or more input interface modules 148, one or more output interface modules 150, one or more network interface modules 158, and one or more memory interface modules 156.

A processing module 132 is described in greater detail at the end of the detailed description section and, in an alternative embodiment, has a direction connection to the main memory 136. In an alternate embodiment, the core control module 130 and the I/O and/or peripheral control module 144 are one module, such as a chipset, a quick path interconnect (QPI), and/or an ultra-path interconnect (UPI).

The processing module 132, the core module 130, and/or the video graphics processing module 140 form a processing core for the improved computer. Additional combinations of processing modules 132, core modules 130, and/or video graphics processing modules 140 form co-processors for the improved computer for technology. Computing resources 124 of FIG. 2E include one more of the components shown in this FIG. and/or in or more of FIGS. 2G-2L.

Each of the main memories 136 includes one or more Random Access Memory (RAM) integrated circuits, or chips. In general, the main memory 136 stores data and operational instructions most relevant for the processing module 132. For example, the core control module 130 coordinates the transfer of data and/or operational instructions between the main memory 136 and the secondary memory device(s) 160. The data and/or operational instructions retrieved from secondary memory 160 are the data and/or operational instructions requested by the processing module or will most likely be used by the processing module. When the processing module is done with the data and/or operational instructions in main memory, the core control module 130 coordinates sending updated data to the secondary memory 160 for storage.

The secondary memory 160 includes one or more hard drives, one or more solid state memory chips, and/or one or more other large capacity storage devices that, in comparison to cache memory and main memory devices, is/are relatively inexpensive with respect to cost per amount of data stored. The secondary memory 160 is coupled to the core control module 130 via the I/O and/or peripheral control module 144 and via one or more memory interface modules 156. In an embodiment, the I/O and/or peripheral control module 144 includes one or more Peripheral Component Interface (PCI) buses to which peripheral components connect to the core control module 130. A memory interface module 156 includes a software driver and a hardware connector for coupling a memory device to the I/O and/or peripheral control module 144. For example, a memory interface 156 is in accordance with a Serial Advanced Technology Attachment (SATA) port.

The core control module 130 coordinates data communications between the processing module(s) 132 and network(s) via the I/O and/or peripheral control module 144, the network interface module(s) 158, and one or more network cards 162. A network card 160 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 158 includes a software driver and a hardware connector for coupling the network card to the I/O and/or peripheral control module 144. For example, the network interface module 158 is in accordance with one or more versions of IEEE 802.11, cellular telephone protocols, 10/100/1000 Gigabit LAN protocols, etc.

The core control module 130 coordinates data communications between the processing module(s) 132 and input device(s) 152 via the input interface module(s) 148, the I/O interface 146, and the I/O and/or peripheral control module 144. An input device 152 includes a keypad, a keyboard, control switches, a touchpad, a microphone, a camera, etc. An input interface module 148 includes a software driver and a hardware connector for coupling an input device to the I/O and/or peripheral control module 144. In an embodiment, an input interface module 148 is in accordance with one or more Universal Serial Bus (USB) protocols.

The core control module 130 coordinates data communications between the processing module(s) 132 and output device(s) 154 via the output interface module(s) 150 and the I/O and/or peripheral control module 144. An output device 154 includes a speaker, auxiliary memory, headphones, etc. An output interface module 150 includes a software driver and a hardware connector for coupling an output device to the I/O and/or peripheral control module 144. In an embodiment, an output interface module 150 is in accordance with one or more audio codec protocols.

The processing module 132 communicates directly with a video graphics processing module 140 to display data on the display 142. The display 142 includes an LED (light emitting diode) display, an LCD (liquid crystal display), and/or other type of display technology. The display has a resolution, an aspect ratio, and other features that affect the quality of the display. The video graphics processing module 140 receives data from the processing module 132, processes the data to produce rendered data in accordance with the characteristics of the display, and provides the rendered data to the display 142.

FIG. 2G is a schematic block diagram of an embodiment of a computing device 120 that includes a plurality of computing resources similar to the computing resources of FIG. 2F with the addition of one or more cloud memory interface modules 164, one or more cloud processing interface modules 166, cloud memory 168, and one or more cloud processing modules 170. The cloud memory 168 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 170 is similar to processing module 132 but is remote from the core control module and is accessed via a network.

FIG. 2H is a schematic block diagram of an embodiment of a computing device 120 that includes a plurality of computing resources similar to the computing resources of FIG. 2G with a change in how the cloud memory interface module(s) 164 and the cloud processing interface module(s) 166 are coupled to the core control module 130. In this embodiment, the interface modules 164 and 166 are coupled to a cloud peripheral control module 172 that directly couples to the core control module 130.

FIG. 2I is a schematic block diagram of an embodiment of a computing device 120 that includes a plurality of computing resources, which includes include a core control module 130, a boot up processing module 176, boot up RAM 174, a read only memory (ROM) 134, a one or more video graphics processing modules 140, one or more displays 48 (optional), an Input-Output (I/O) peripheral control module 144, one or more input interface modules 148, one or more output interface modules 150, one or more cloud memory interface modules 164, one or more cloud processing interface modules 166, cloud memory 168, and cloud processing module(s) 170.

In this embodiment, the computing device 120 includes enough processing resources (e.g., module 176, ROM 134, and RAM 174) to boot up. Once booted up, the cloud memory 168 and the cloud processing module(s) 170 function as the computing device's memory (e.g., main and hard drive) and processing module.

FIG. 2J is a schematic block diagram of another embodiment of a computing device 120 that includes a hardware section 180 and a software program section 182. The hardware section 180 includes the hardware functions of power management, processing, memory, communications, and input/output. FIG. 2L illustrates the hardware section 180 in greater detail.

The software program section 182 includes an operating system 184, system and/or utilities applications, and user applications. The software program section further includes APIs and HWIs. APIs (application programming interface) are the interfaces between the system and/or utilities applications and the operating system and the interfaces between the user applications and the operating system 184. HWIs (hardware interface) are the interfaces between the hardware components and the operating system. For some hardware components, the HWI is a software driver. The functions of the operating system 184 are discussed in greater detail with reference to FIG. 2K.

FIG. 2K is a diagram of an example of the functions of the operating system of a computing device 120. In general, the operating system function to identify and route input data to the right places within the computer and to identify and route output data to the right places within the computer. Input data is with respect to the processing module and includes data received from the input devices, data retrieved from main memory, data retrieved from secondary memory, and/or data received via a network card. Output data is with respect to the processing module and includes data to be written into main memory, data to be written into secondary memory, data to be displayed via the display and/or an output device, and data to be communicated via a network care.

The operating system 184 includes the OS functions of process management, command interpreter system, I/O device management, main memory management, file management, secondary storage management, error detection & correction management, and security management. The process management OS function manages processes of the software section operating on the hardware section, where a process is a program or portion thereof.

The process management OS function includes a plurality of specific functions to manage the interaction of software and hardware. The specific functions include:
load a process for execution;
enable at least partial execution of a process;
suspend execution of a process;
resume execution of a process;
terminate execution of a process;
load operational instructions and/or data into main memory for a process;
provide communication between two or more active processes;
avoid deadlock of a process and/or interdependent processes; and
control access to shared hardware components.

The I/O Device Management OS function coordinates translation of input data into programming language data and/or into machine language data used by the hardware components and translation of machine language data and/or programming language data into output data. Typically, input devices and/or output devices have an associated driver that provides at least a portion of the data translation. For example, a microphone captures analog audible signals and converts them into digital audio signals per an audio encoding format. An audio input driver converts, if needed, the digital audio signals into a format that is readily usable by a hardware component.

The File Management OS function coordinates the storage and retrieval of data as files in a file directory system, which is stored in memory of the computing device. In general, the file management OS function includes the specific functions of:
File creation, editing, deletion, and/or archiving;
Directory creation, editing, deletion, and/or archiving;
Memory mapping files and/or directors to memory locations of secondary memory; and
Backing up of files and/or directories.

The Network Management OS function manages access to a network by the computing device. Network management includes
Network fault analysis;
Network maintenance for quality of service;
Network access control among multiple clients; and
Network security upkeep.

The Main Memory Management OS function manages access to the main memory of a computing device. This includes keeping track of memory space usage and which processes are using it; allocating available memory space to requesting processes; and deallocating memory space from terminated processes.

The Secondary Storage Management OS function manages access to the secondary memory of a computing device. This includes free memory space management, storage allocation, disk scheduling, and memory defragmentation.

The Security Management OS function protects the computing device from internal and external issues that could adversely affect the operations of the computing device. With respect to internal issues, the OS function ensures that processes negligibly interfere with each other; ensures that processes are accessing the appropriate hardware components, the appropriate files, etc.; and ensures that processes execute within appropriate memory spaces (e.g., user memory space for user applications, system memory space for system applications, etc.).

The security management OS function also protects the computing device from external issues, such as, but not limited to, hack attempts, phishing attacks, denial of service attacks, bait and switch attacks, cookie theft, a virus, a trojan horse, a worm, click jacking attacks, keylogger attacks, eavesdropping, waterhole attacks, SQL injection attacks, and DNS spoofing attacks.

FIG. 2L is a schematic block diagram of the hardware components of the hardware section 180 of a computing device. The memory portion of the hardware section includes the ROM 134, the main memory 136, the cache memory 138, the cloud memory 168, and the secondary memory 160. The processing portion of the hardware section includes the core control module 130, the processing module 132, the video graphics processing module 140, and the cloud processing module 170.

The input/output portion of the hardware section includes the cloud peripheral control module 172, the I/O and/or peripheral control module 144, the network interface module 158, the I/O interface module 146, the output device interface 150, the input device interface 148, the cloud memory interface module 164, the cloud processing interface module 166, and the secondary memory interface module 156. The IO portion further includes input devices such as a touch screen, a microphone, and switches. The IO portion also includes output devices such as speakers and a display.

The communication portion includes an ethernet transceiver network card (NC), a WLAN network card, a cellular transceiver, a Bluetooth transceiver, and/or any other device for wired and/or wireless network communication.

FIG. 2M is a schematic block diagram of an embodiment of a database that includes a data input computing entity 190, a data organizing computing entity 192, a data query processing computing entity 194, and a data storage computing entity 196. Each of the computing entities is an implementation in accordance with one or more of the embodiments of FIGS. 2A through 2E.

The data input computing entity 190 is operable to receive an input data set 198. The input data set 198 is a collection of related data that can be represented in a tabular form of columns and rows, and/or other tabular structure. In an example, the columns represent different data elements of data for a particular source and the rows corresponds to the different sources (e.g., employees, licenses, email communications, etc.).

If the data set 198 is in a desired tabular format, the data input computing entity 190 provides the data set to the data organizing computing entity 192. If not, the data input computing entity 190 reformats the data set to put it into the desired tabular format.

The data organizing computing entity 192 organizes the data set 198 in accordance with a data organizing input 202. In an example, the input 202 is regarding a particular query and requests that the data be organized for efficient analysis of the data for the query. In another example, the input 202 instructions the data organizing computing entity 192 to organize the data in a time-based manner. The organized data is provided to the data storage computing entity for storage.

When the data query processing computing entity 194 receives a query 200, it accesses the data storage computing entity 196 regarding a data set for the query. If the data set is stored in a desired format for the query, the data query processing computing entity 194 retrieves the data set and executes the query to produce a query response 204. If the data set is not stored in the desired format, the data query processing computing entity 194 communicates with the data organizing computing entity 192, which re-organizes the data set into the desired format.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence-i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed used by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed used by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A client device comprising:
a network interface configured for communicating via at least one network;
a processing system having a plurality of processors; and
a memory that stores executable instructions, which when executed by the processing system, cause the processing system to perform operations of at least one game application that supports a mixed-reality game, wherein the operations include:
generating first telemetry data corresponding to a first gaming object in a first game space, wherein the first gaming object is a first physical object that operates in the first game space under control of the client device based on interactions with a first player and wherein the first game space is a physical space in proximity to the client device; and
sending the first telemetry data to an other client device of a second player controlling a second gaming object in the mixed-reality game along with first gaming data that is sent to the other client device to facilitate real-time remote game play of the mixed-reality game between the first gaming object and the second gaming object.

2. The client device of claim 1, wherein the second gaming object is a second physical object that operates in a second game space under control of the other client device and wherein the second game space is a physical space in proximity to the other client device and remote from the first game space.

3. The client device of claim 2, wherein the first telemetry data includes first position and orientation data corresponding to the positioning of the first gaming object relative to a first beacon device in the first game space;
wherein the first gaming data facilitates real-time game play of the mixed-reality game between the first gaming object and the second gaming object based on a first mixed-reality display that includes a first virtual reality representation as a proxy for the first gaming object and is presented to the second player via the other client device; and
wherein the first mixed reality display positions and orients the first virtual reality representation in the second game space based on the first position and orientation data.

4. The client device of claim 3, wherein the operations of the at least one game application further include:
receiving second gaming data corresponding to the mixed-reality game that is generated based on second telemetry data corresponding to the second gaming object in the second game space, the second gaming data representing the second gaming object as a second virtual reality representation as a proxy for the second gaming object, wherein the second telemetry data includes second position and orientation data corresponding to the second gaming object relative to a second beacon device in the second game space; and
generating a second mixed-reality display presented to the first player that includes a second virtual reality representation as a proxy for the second gaming object and is via the client device, wherein the second mixed reality display positions and orients the second virtual reality representation in the first game space based on the second position and orientation data.

5. The client device of claim 4, wherein the first telemetry data includes first action data corresponding to other game play actions of the first gaming object, wherein the first telemetry data and the first mixed-reality display are further generated to reflect the other game play; and
wherein the second gaming data includes second action data corresponding to other game play actions of the second gaming object, and wherein the second gaming data and the second mixed-reality display are further generated to reflect the other game play actions of the first gaming object.

6. The client device of claim 4, wherein the second mixed-reality display includes a visual enhancement of the first gaming object that is based on augmented reality.

7. The client device of claim 3, wherein the first mixed-reality display includes a visual enhancement of the second gaming object that is based on augmented reality.

8. The client device of claim 2, wherein the first telemetry data includes position and orientation data corresponding to the positioning of the first gaming object relative to a first beacon device in the first game space;
wherein the first gaming data facilitates real-time game play of the mixed-reality game between the first gaming object and the second gaming object based a first physical proxy for the first gaming object in the second game space and based on a first mixed-reality display that is presented to the second player via the other client device; and
wherein the second gaming data facilitates orientation of the first physical proxy in the second game space based on the position and orientation data.

9. The client device of claim 3, wherein the first beacon device includes at least one beacon transmitter configured to transmit at least one wireless beacon and the first gaming object includes at least one beacon receiver and wherein the first position and orientation data is generated based on reception of the at least one beacon via the at least one beacon receiver.

10. The client device of claim 9, wherein the at least one wireless beacon includes one or more of: an ultrasonic beacon or an infrared beacon.

11. The client device of claim 10, wherein the infrared beacon is emitted vertically and reflected by a spinning mirror that redirects the infrared beacon across a 360 sweep in a horizontal plane.

12. The client device of claim 10, wherein the first gaming device determines a distance to the first beacon device based on a one-way time of travel of a ultrasonic beacon from the first beacon device to the first gaming device.

13. The client device of claim 9, wherein the first gaming device includes a plurality of motion sensors that generate motion data, wherein the first position and orientation data is generated further based on the motion data and wherein the motion sensors include at least one:
accelerometer, gyrometer, magnetometer and wheel encoder corresponding to at least one wheel of the first gaming device.

14. The client device of claim 13, wherein the client device includes a camera configured to capture image data of the first game space, wherein the client device utilizes computer vision to generate tracking data associated with the first gaming device and the first beacon device, wherein the first position and orientation data is generated further based on the tracking data and wherein the client device generates the first mixed-reality display based on the captured image data.

15. The client device of claim 13, wherein the first telemetry data includes impact data generated based on the motion data and responsive to one or more physical impacts to the first gaming object by the second gaming object during the real-time remote game play of the mixed-reality game between the first gaming object and the second gaming object and wherein the impact data is further based on detection of virtual impacts to the first gaming object responsive to the real-time remote game play of the mixed-reality game.

16. The client device of claim 15, wherein the first gaming device includes a base portion, an ejectable portion that is mechanically coupleable to the base portion and an ejection actuator, and wherein the ejection actuator operates to eject the ejectable portion from the base portion based on the impact data.

17. The client device of claim 1, wherein the first gaming device includes a plurality of motion actuators for controlling motion of the first gaming device and at least one game play action device that produces other game play actions of the first gaming device that operate under control of commands generated by the client device.

18. The client device of claim 1, wherein the first gaming object operates in the first game space under control of the client device in one of a plurality of modes selected by the first player, wherein the plurality of modes include two or more of: player controlled game play, artificial intelligence (AI) assisted game play or AI controlled game play.

19. A method for use with a client device that includes a processing system, a memory, and network interface configured for communicating via at least one network, the method comprising:
generating first telemetry data corresponding to a first gaming object in a first game space, wherein the first gaming object is a first physical object that operates in the first game space under control of the client device based on interactions with a first player and wherein the first game space is a physical space in proximity to the client device; and
sending the first telemetry data to a mixed-reality gaming platform in communication with an other client device of a second player controlling a second gaming object in the mixed-reality game to support the generation of first gaming data that is sent to the other client device to facilitate real-time remote game play of the mixed-reality game between the first gaming object and the second gaming object.

20. A mixed-reality gaming platform comprising:
a network interface configured for communicating via at least one network;
a processing system having a plurality of processors; and
a memory that stores executable instructions, which when executed by the processing system, cause the processing system to perform operations of at least one game process which include:
receiving, via the network interface, first telemetry data corresponding to a first gaming object in a first game space, wherein the first gaming object is a first physical object that operates in the first game space under control of a first client device of a first player and wherein the first game space is a physical space in proximity to the first client device;
generating first gaming data corresponding to a mixed-reality game, the first gaming data based on a positioning of the first gaming object in the mixed-reality game; and
sending the first gaming data to a second client device of a second player controlling a second gaming object in the mixed-reality game to facilitate real-time remote game play of the mixed-reality game between the first gaming object and the second gaming object.
